(19) United States
(12) Patent Application Publication
(10) Pub. No.: US 2007/0234064 A1
(43) Pub. Date: Oct. 4, 2007

(54) Identification information output device

(75) Inventor: Tomoyuki Nihei, Iruma-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/729,416

(22) Filed: Mar. 28, 2007

(30) Foreign Application Priority Data
Mar. 29, 2006 (JP) 2006-090245
Mar. 29, 2006 (JP) 2006-091144

(51) Int. Cl. H04L 9/00

(52) U.S. Cl. 713/183

(57) ABSTRACT

An identification information output device comprises a storage unit configured to store items of seed information for generating identification information, a selection unit configured to select one of the items of the seed information stored in the storage unit in response to a user operation, a generation unit configured to generate identification information based on a predetermined algorithm using the item of the seed information selected by the selection unit, and an output unit configured to output the identification information generated by the generation unit.

### CROSS-REFERENCE TO RELATED APPLICATIONS

This application is based upon and claims the benefit of priority from prior Japanese Patent Applications No. 2006-090245, filed Mar. 29, 2006; and No. 2006-091144, filed Mar. 29, 2006, the entire contents of both of which are incorporated herein by reference.

### BACKGROUND OF THE INVENTION

1. Field of the Invention

The present invention relates to an identification information output device.

2. Description of the Related Art

A variety of authentication schemes based on password authentication are practically used as a method for ensuring security at the time of access to a computer or a communication network. A fixed password (fixed identification information) or a One Time Password hereinafter, referred to as OTP) is used as a password. In an authentication scheme using a fixed password, there is a disadvantage that a password is identified by use of a tool such as password cracking tool, easily providing an illegal access. In contrast, an authentication scheme using OTP is featured in that authentication is carried out by means of a temporary password that changes with time or the like, thus making it more difficult to provide an illegal access.

An authentication system using an OTP authentication scheme includes an OTP generator for generating an OTP (so called token) and an authentication server for executing authentication (hereinafter, referred to as an OTP authentication site). The OTP generator stores one item of unique seed information in a storage device such as a built-in ROM (Read Only Memory). This seed information and current time information obtained by a clock unit are computed by means of a predetermined coding algorithm, thereby generating identification information, i.e., an OTP. A user who is an authentication system user inputs the generated OTP together with a login ID (user ID) by using a terminal device such as a PC (Personal Computer) at the time of login to a desired server or system.

On the other hand, seed information identical to that stored in the OTP generator is stored in an authentication site. Namely, the OTP generator and the authentication server each store the identical seed information, and the authentication server stores seed information corresponding to the number of OTP generators distributed to a user. In the authentication site, the seed information corresponding to the OTP generator of the user who has carried out login and the current time information obtained by the built-in clock unit are computed in accordance with a coding algorithm identical to the OTP generator, thereby generating a crosscheck OTP. Then, user authentication is carried out by means of crosschecking the crosscheck OTP and a user input OTP.

Note that, at the time of authentication site login, there is a need for inputting account information such as a login ID or a password every time. However, in the case where there exist a plurality of authentication sites that can be logged in, a user must memorize a number of login IDs or passwords and management of these IDs and passwords becomes complicated. Therefore, there has been prevalent a technique called password bank in which URLs (Uniform Resource Locators), login IDs and fixed passwords of a plurality of authentication sites (hereinafter, referred to as an RP authentication site) corresponding to the authentication scheme using the fixed password are managed in batch without the user inputting account information at the time of login. For example, there has been proposed a technique of storing a login ID or a fixed password in a memory device equipped with an USB (Universal Serial Bus) terminal so as to be automatically read out at the time of login (reference should be made to Jpn. Pat. Appln. KOKAI Publication No. 2002-312326, for example).

However, the technique described in the above patent document presumes use of a fixed password. Thus, there is a problem that this technique cannot be used for an authentication site (hereinafter, referred to as an OTP authentication site) that corresponds to an OTP authentication scheme. Therefore, the above technique is inconvenient because account information registered in a password bank is utilized at the time of login to an authentication site that corresponds to a fixed password authentication scheme; an OTP is generated by separate use of an OTP generator such as a so called token at the time of login to an OTP authentication site; and then, login is achieved by use of this OTP.

### BRIEF SUMMARY OF THE INVENTION

It is an object of the present invention to improve convenience relevant to operation and use of seed information in an authentication system that uses an authentication scheme with a One Time Password.

According to one aspect of the present invention, an identification information output device comprises:

a storage unit configured to store items of seed information for generating identification information;

a selection unit configured to select one of the items of the seed information stored in the storage unit in response to a user operation;

a generation unit configured to generate identification information based on a predetermined algorithm using the item of the seed information selected by the selection unit; and

an output unit configured to output the identification information generated by the generation unit.

According to another aspect of the present invention, an identification information output device comprises:

a seed information storage unit configured to store an item or items of seed information corresponding to one or plural authentication sites that carry out authentication based on a one time password for crosscheck;

a generation unit configured to generate a one time password based on a predetermined algorithm using the item or items of seed information stored in the seed information storage unit;

a fixed identification information storage unit configured to store an item or items of fixed identification information corresponding to one or plural authentication sites that carry out authentication based on a one time password for crosscheck;

a readout unit configured to read out the item or items of fixed identification information stored in the fixed identification information storage unit;

a control unit configured to, in accordance with an authentication scheme of an authentication site of a connection destination, cause the generation unit to generate a one time password corresponding to the authentication site of a connection destination or the readout unit to read out the item of fixed identification information corresponding to the authentication site of a connection destination; and

an output unit configured to output the one time password generated by the generation unit or the item of fixed identification information read out by the readout unit.

According to another aspect of the present invention, an identification information output device communicably connected to a terminal device which is connected to authentication sites via a communication network, the output device comprises:

a seed information storage unit configured to store an item or items of seed information corresponding to one or plural authentication sites that carry out authentication based on a one time password for crosscheck;

a generation unit configured to generate a one time password based on a predetermined algorithm using the item or items of seed information stored in the seed information storage unit;

a fixed identification information storage unit configured to store an item or items of fixed identification information corresponding to one or plural authentication sites that carry out authentication based on a one time password for crosscheck;

a readout unit configured to read out the item or items of fixed identification information stored in the fixed identification information storage unit;

a control unit configured to, in accordance with an authentication scheme of an authentication site of a connection destination, cause the generation unit to generate a one time password corresponding to the authentication site of a connection destination or the readout unit to read out the item of fixed identification information corresponding to the authentication site of a connection destination; and

a transmission unit configured to transmit the one time password generated by the generation unit or the item of fixed identification information read out by the readout unit to the terminal device.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a view showing a configuration of an authentication system according to the first embodiment;

FIG. 2 is a view showing an internal configuration of an OTP generator;

FIG. 3 is a view showing an example of a seed table;

FIG. 4 is a view showing an example of an account information management table;

FIG. 5 is a block diagram showing an internal configuration of an access terminal;

FIG. 6 is a block diagram showing an internal configuration of an RP authentication server;

FIG. 7 is a view showing an example of a user by user fixed password table;

FIG. 8 is a view showing an internal configuration of an OTP authentication server;

FIG. 9 is a view showing an example of a user by user seed information table;

FIG. 10 is a block diagram showing an internal configuration of a seed information management server;

FIG. 11 is a view showing an example of a business person/company information table;

FIG. 12 is a view showing an example of a seed information management table;

FIG. 13 is a view schematically showing a step for constructing an authentication system;

FIG. 14 is a flow chart showing procedures for executing a process relevant to manufacture of an OTP generator;

FIG. 15 is a flow chart showing procedures for executing a process relevant to registration into a seed information management table;

FIG. 16 is a flow chart showing procedures for executing a process relevant to registration into a business person/company information table;

FIG. 17 is a view for explaining assignment of seed numbers to business persons/companies;

FIG. 18 is a ladder chart showing procedures for executing a process (RP user registering process) relevant to registration of user information into an RP authentication server;

FIG. 19 is a flow chart showing a process executed by means of an OTP generator at the time of registration of user information;

FIG. 20 is a view showing an example of an OTP generator-specific ID displayed at a display device of the OTP generator;

FIG. 21 is a ladder chart showing procedures for executing a process (OTP user registering process) relevant to registration of user information into an OTP authentication server;

FIG. 22 is a flow chart showing procedures for executing a process relevant to a seed information retrieve process of FIG. 21;

FIG. 23 is a flow chart showing procedures for executing a process relevant to a user information registration process of FIG. 21;

FIG. 24 is a flow chart showing procedures for executing a process (account information managing process) relevant to registration into an account information management table;

FIG. 25 is a ladder chart showing procedures for executing a process by means of an OTP generator and an access terminal at the time of login to an RP authentication server or an OTP authentication server in the first embodiment;

FIG. 26 is a view showing an example of a screen displayed at a display device of the access terminal;

FIG. 27 is a view showing an example of a site name displayed at a display device of the OTP generator;

FIG. 28 is a view showing an example of a screen displayed at the display device of the OTP generator;

FIG. 29 is a flow chart showing procedures for executing a process by means of the OTP generator at the time of login to an RP authentication server or an OTP authentication server in the second embodiment;

FIG. 30 is a view showing an example of a site name, a URL, a login ID, and a fixed password that are displayed at the display device of the OTP generator;

FIG. 31 is a view showing an example of a site name, a URL, a login ID, and an OTP that are displayed at the display device of the OTP generator;

FIG. 32 is a view showing an example of a login screen displayed at the display device of the access terminal;

FIG. 33 is a view showing a configuration of an authentication system according to the third embodiment;

FIG. 34 is a block diagram showing an internal configuration of a login management server;

FIG. 35 is a ladder chart showing procedures for executing a process by means of an OTP generator, an access terminal, and a login management server at the time of login to an RP authentication server or an OTP authentication server in the third embodiment;

FIG. 36 is a ladder chart showing procedures for executing a process by means of the OTP generator, the access terminal, and the login management server at the time of login to the RP authentication server or the OTP authentication server in the third embodiment;

FIG. 37 is a view showing an example of a screen displayed at the display device of the access terminal;

FIG. 38 is a view showing an example of a site name displayed at the display device of the access terminal;

FIG. 39 is a view showing an example of a screen displayed at the display device of the access terminal;

FIG. 40 is a ladder chart showing procedures for executing a process by means of an OTP generator, an access terminal, and a login management server at the time of login to an RP authentication server or an OTP authentication server in the fourth embodiment;

FIG. 41 is a ladder chart showing procedures for executing a process by means of the OTP generator, the access terminal, and the login management server at the time of login to the RP authentication server or the OTP authentication server in the fourth embodiment;

FIG. 42 is a view showing an example of a seed number displayed at the display device of the access terminal;

FIG. 43 is a flow chart showing a flow of a process executed by means of an OTP generator;

FIG. 44 is a view showing an example of an OTP displayed at the display device of the OTP generator;

FIG. 45 is a view showing an internal configuration of an OTP generator according to the fifth embodiment;

FIG. 46 is a view showing an example of a seed number management table in the fifth embodiment;

FIG. 47 is a flow chart showing procedures for executing a process relevant to registration into the seed number management table in the fifth embodiment;

FIG. 48 is a flow chart showing a process executed by means of an OTP generator at the time of login in the fifth embodiment;

FIG. 49 is a view showing an example of a seed number, business person/company identification information, and an OTP that are displayed at the display device of the OTP generator in the fifth embodiment; and

FIG. 50 is a ladder chart showing procedures for executing a process relevant to login to an OTP authentication server 40 in the fifth embodiment.

### DETAILED DESCRIPTION OF THE INVENTION

An embodiment of an identification information output device according to the present invention will now be described with reference to the accompanying drawings. The invention is not limited to the illustrated examples.

### First Embodiment

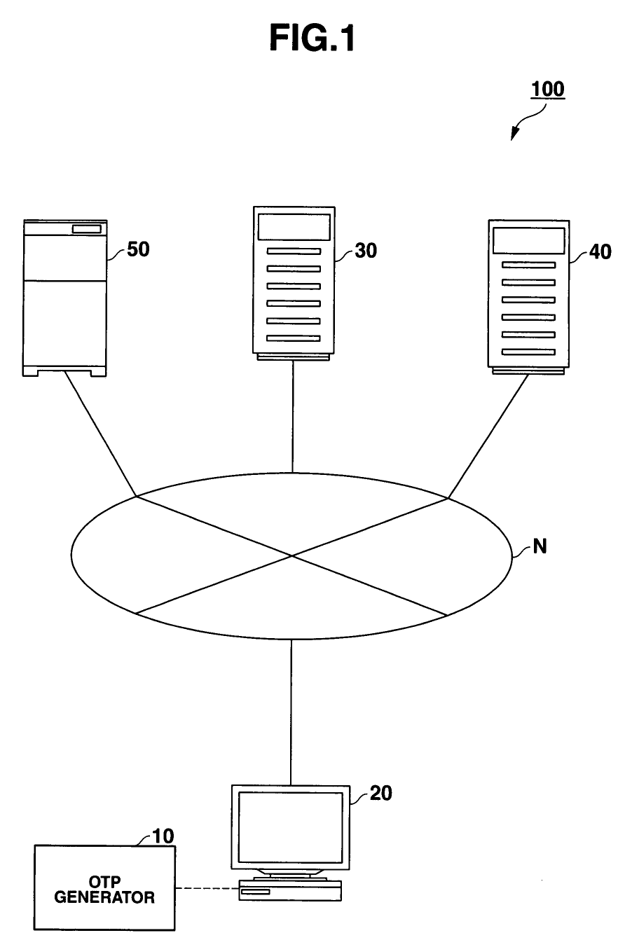

A configuration of an authentication system 100 according to the present embodiment will be described referring to FIG. 1. The authentication system 100 includes an OTP generator 10; an access terminal 20; an RP authentication server 30; an OTP authentication server 40; and a seed information management server 50. At least the access terminal 20 is connected to the RP authentication server 30 and the OTP authentication server 40 and the authentication server 40 is connected to the seed information management server 50 via a network N so that data can be transmitted to and received from each other. The number of devices configuring the authentication system 100 is not limited to that of an illustrative example. A network configuration constituted by devices is not limited to that of an illustrative example. For example, the OTP authentication server 40 and the seed information management server 50 may be connected to each other via another network.

While the network N is a WAN (Wide Area Network), for example, it may be a LAN (Local Area Network), or alternatively, may be a telephone line network; an ISDN (Integrated Service Digital Network) line network; a broadband communication line network; a leased line; a mobile unit communication network; a communication satellite line; a CATV (Community Antenna Television) line; an optical communication line; a radio communication lime; and an internet service provider for connecting them or the like. While a data communication protocol between devices is not limited in particular, for example, it is preferable to use a protocol considering security such as TLS/SSL, S/MIME, or IPsec. A unique protocol may also be used.

The OTP generator 10 is a so called token distributed to each user who uses the authentication system 100, and generates an OTP serving as user identification information in the authentication system 100 from seed information and time information in response to a user operation via an operating device 12.

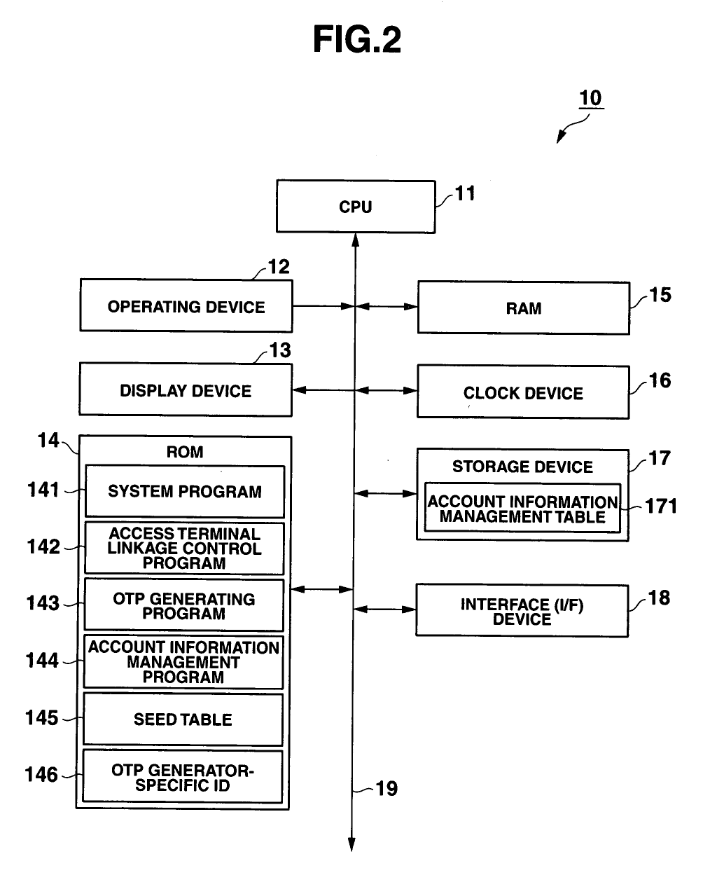

FIG. 2 is a block diagram showing an internal configuration of the OTP generator 10. The OTP generator 10 includes constituent elements such as a CPU 11, an operating device 12, a display device 13, a ROM 14, a RAM 15, a clock device 16, a storage device 17, and an interface (I/F) device 18. These constituent elements are connected via a bus line 19.

The CPU 11 executes a variety of processes in cooperation with a variety of programs stored in advance in the ROM 14 while the RAM 15 is used as a work area. This CPU controls an operation of each of constituent elements that configure the OTP generator 10.

The operating device 12 is equipped with a variety of input keys or the like, and outputs to the CPU 11 an input signal input by means of a user operation. The display device 13 includes a panel such as an LCD (Liquid Crystal Display) or ELD (Electro Luminescence Display) panel, and displays a variety of information based on a display signal from the CPU 11. The display device 13 may configure a touch panel integrally with the operating device 12.

The ROM 14 stores a program required for an operation of the OTP generator 10 and data relevant to execution of the program. The ROM 14 stores a system program 141; an access terminal linkage control program 142; an OTP generating program 143; an account information management program 144; a seed table 145; and an OTP generator-specific ID 146.

The system program 141 is provided as a program for implementing basic functions as an OTP generator. The CPU 11 implements write and read control of a variety of data into and from the storage device 17; display control of the display device 13; input control of assigning execution of a predetermined function to a predetermined input key of the operating device 12, and the like, under cooperation with the system program 141.

The access terminal linkage control program 142 is provided as a program for implementing functions relevant to linkage with the access terminal 20. Specifically, this program implements an operation of executing a variety of programs such as the account information management program 144 in accordance with a variety of instruction information transmitted from the access terminal 20 connected via the I/F device 18, reading out account information registered in an account information management table 171; recording the accounting information and the like, under cooperation with a CPU 11.

The OTP generating program 143 is provided as a program for implementing functions relevant to generation of an OTP. The CPU 11 generates an OTP under a predetermined algorithm based on one item of seed information and the time information that is input from the clock device 16, under cooperation with the OTP generating program 143.

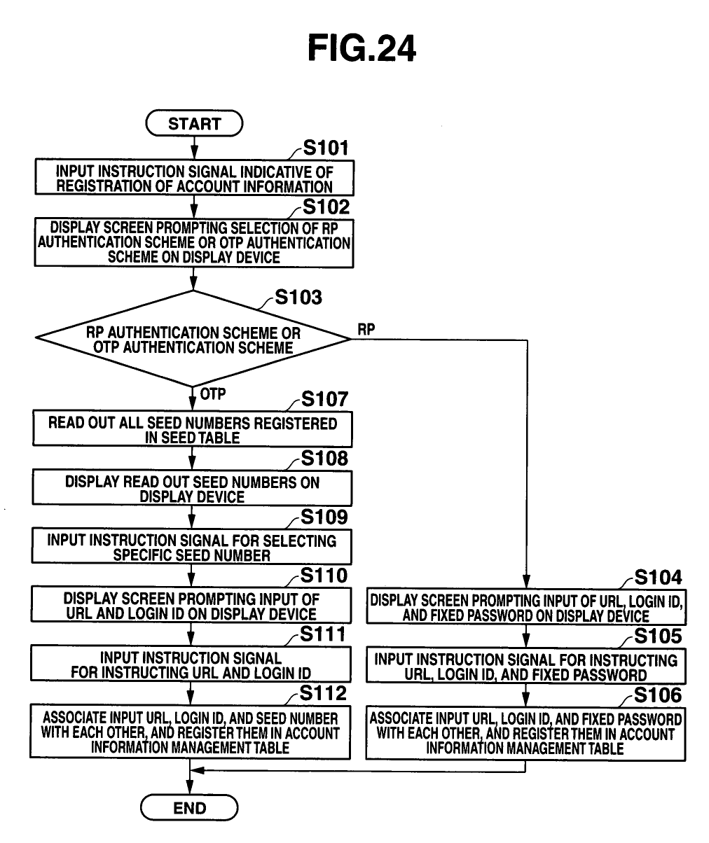

The account information management program 144 is provided as a program for implementing functions relevant to storage/management of the account information management table 171 stored in the storage device 17. The CPU 11 is caused to execute an account information managing process (refer to FIG. 24) under cooperation with the account information management program 144.

In the seed table 145, a plurality of items of seed information are registered in association with a plurality of seed numbers (selection information), each of which corresponds to each one of the plurality of items of seed information.

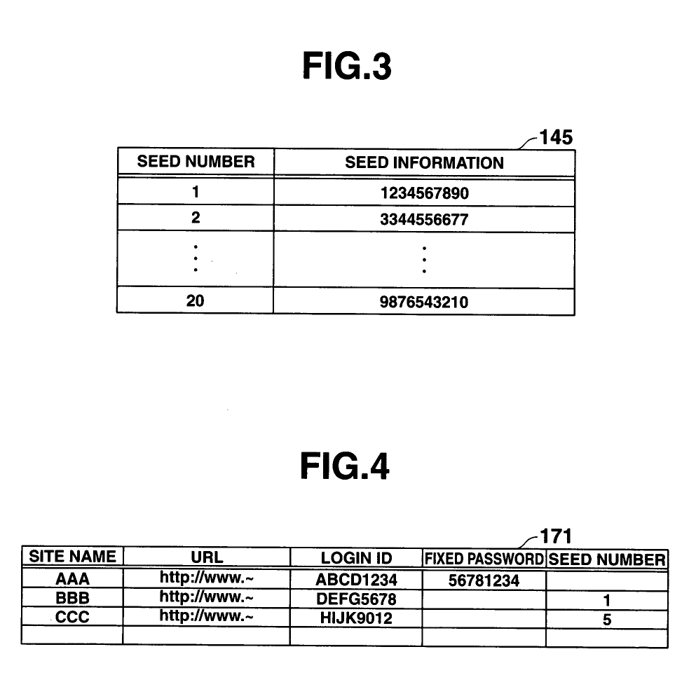

FIG. 3 is a view showing an example of the seed table 145 stored in the ROM 14. In the seed table 145, a plurality of items of seed information (such as 1234567890) and a plurality of seed numbers (1 to 20), each of which corresponds to each one item of the plurality of items of seed information are registered in association with each other. Any particular quantity of seed information may be registered in the seed table 145 without being limited to an illustrative example. When a user selects a specific seed number via the operating device 12, the CPU 11 reads out seed information corresponding to the selected seed number from the seed table 145, and then, generates an OTP based on the read out seed information and the time information on the clock device 16 under cooperation with the OTP generating program 143. The CPU 11 transmits the thus generated OTP to an external device via the I/F device 18 or causes the display device 13 to display the OTP.

The OTP generator-specific ID 146 is provided as a specific ID such as a manufacturing number assigned to each OTP generator 10. The CPU 11 reads the OTP generator-specific ID 146 from the ROM 14 in response to a specific user operation via the operating device 12, and then, transmits the read out ID to an external device via the I/F device 18 or causes the display device 13 to display the ID.

The RAM 15 is provided as a temporary storage area for programs, input or output data, parameters and the like read out from the ROM 14 in a variety of processes executed and controlled by means of the CPU 11.

The clock device 16 measures a current time based on a clock signal generated by a quartz oscillator (not shown) for always generating a predetermined frequency signal, and then, outputs the thus measured time information to the CPU 11.

The storage device 17 is equipped with a nonvolatile storage medium formed of a magnetic or optical recording medium or a semiconductor memory, and stores the account information management table 171 in this storage medium. The storage medium may be configured so as to be removably mountable on the OTP generator 10.

In the account information management table 171, a site name serving as an access destination and a variety of information required for login to an authentication site of this site name are registered in association with each other. The information registered in the account information management table 171 is provided as information input from a user via the operating device 12 or the like in an account information managing process described later (refer to FIG. 24). For example, address information such as an URL or an IP address indicating a connection destination address of each site, a login ID required at the time of login and the like can be input.

FIG. 4 is a view showing an example of the account information management table 171. In the account information management table 171, a plurality of site names (AAA, BBB, CCC) serving as access destinations, URLs, login IDs, fixed passwords, or seed numbers corresponding to seed information that serves as a source of OTP generation are registered in association with each authentication site (site name). Hereinafter, groups of the above described site names, login IDs, fixed passwords, or seed numbers are referred to as account information.

When a specific site name is selected by means of a user operation from the operating device 12, the CPU 11 refers to the account information management table 171, reads out account information that corresponds to the selected site name, and then, transmits the read out account information to an external device via the I/F device 18 or causes the display device 13 to display the information.

The I/F device 18 is provided as a communication interface that makes communication control of a variety of information exchanged between the OTP generator 10 and an external device such as the access terminal 20, under the control of the CPU 11. The I/F device 18, for example, can include a serial input/output terminal such as a USB (Universal Serial Bus) port or an RS-232C terminal, a parallel input/output terminal, an SCSI interface, an infrared-ray communication device that conforms to an IrDA (Infrared Data Association) standard, a radio communication device that conforms to a Bluetooth® standard, and the like, and can be connected to an interface (I/F) device 27 of the access terminal 20 by wired or radio communication means. Specifically, a variety of information such as a seed number or an OTP generator-specific ID, account information, and an OTP are transmitted from the OTP generator 10 to the access terminal 20 via the I/F device 18.

The access terminal 20 is provided as a terminal device such as a PC operated by a user who uses the authentication system 100, and provides an access to each device connected to the network N.

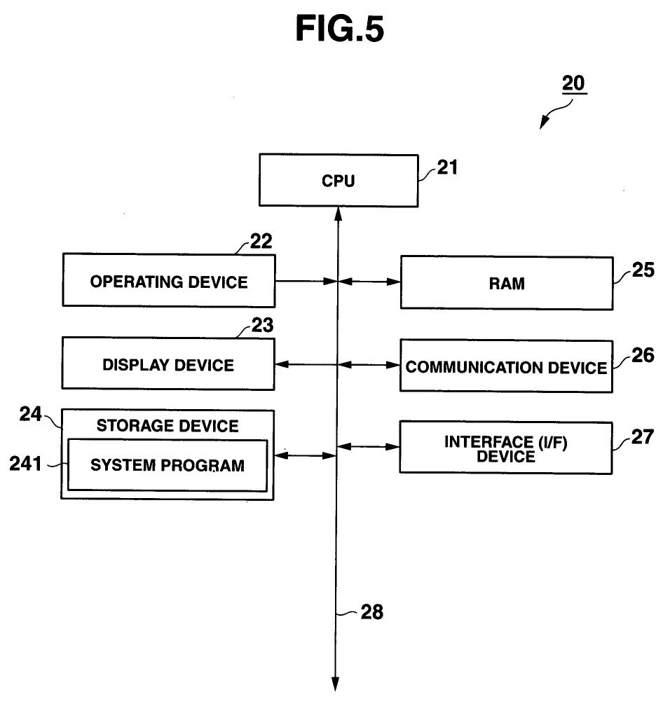

FIG. 5 is a block diagram showing an internal configuration of the access terminal 20. The access terminal 20 includes a CPU 21, an operating device 22, a display device 23, a storage device 24, a RAM 25, a communication device 26, and an I/F device 27 which are connected via a bus line 28.

The CPU 21 executes a variety of processes under cooperation with a plurality of programs stored in advance in the storage device 24 while the RAM 25 is used as a work area. The CPU 21 controls an operation of each of the elements that configure the access terminal 20.

The operating device 22 is equipped with a variety of input keys or the like, and outputs to the CPU 21 an input signal input by means of a user operation. The display device 23 includes a panel such as an LCD or ELD panel, and displays a variety of information based on a display signal from the CPU 21. The display device 23 may configure a touch panel integrally with the operating device 22.

The storage device 24 is equipped with a nonvolatile storage medium formed of a magnetic or an optical recording medium or a semiconductor memory, and stores a program required for an operation of the access terminal 20 and data relevant to execution of the program. The storage device 24 stores a system program 241, as shown in FIG. 5.

The system program 241 is provided as a program for implementing basic functions as an access terminal. The CPU 21 implements write and read control of a variety of data to and from the storage device 24, display control of the display device 23, input control of assigning execution of a predetermined function to a predetermined input key of the operating device 22, and the like, under cooperation with the system program 241. The CPU 21 implements an information receiving function for providing an access (connection) to the RP authentication server 30 or the OTP authentication server 40, and then, receiving a screen, information and the like provided for authentication, under cooperation with the system program 241, and, for example, implements a function serving as a Web client.

The RAM 25 is provided as a temporary storage area for programs, input or output data, parameters or the like read out from the storage device 24 in a variety of processes executed and controlled by means of the CPU 21.

The communication device 26 is provided as a network interface such as a modem (MOdulator/DEModulator), a terminal adaptor, or a LAN adaptor, and makes communication control of a variety of information exchanged with another device (such as OTP authentication server 40) connected to the network N under the control of the CPU 21.

The I/F device 27 is provided as a communication interface that makes communication control of a variety of information exchanged between the access terminal 20 and the external device such as the OTP generator 10 under the control of the CPU 21. The I/F device 27, for example, can include a serial input/output terminal including a USB port or an RS-232C terminal, a parallel input/output terminal, an SCSI interface, an infrared ray communication device that conforms to an IrDA standard, a radio communication device that conforms to a Bluetooth standard, and the like, and can be connected to the I/F device 18 of the OTP generator 10 by wired or radio communication means. In the case where the I/F device 27 is connected to the I/F device 18 of the OTP generator 10, both of the interface (I/F) sections may use a communication interface that conforms to a common standard.

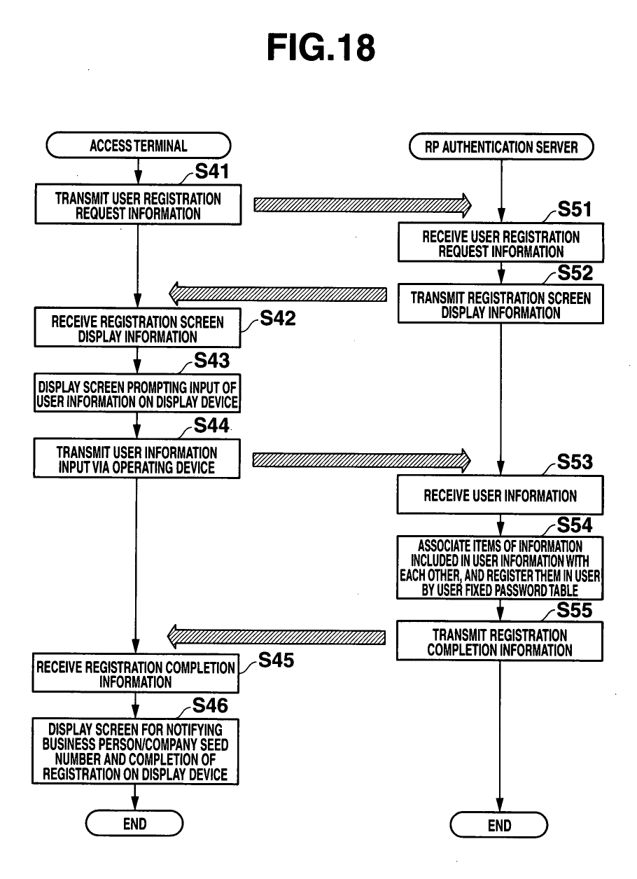

An RP (Reusable Password) authentication server 30 is provided as an authentication server (RP authentication site) that belongs to each business person/company. The RP authentication server 30 determines whether or not a user of the access terminal 20 is a user registered by means of an RP user registering process described later (refer to FIG. 18) based on a login ID and a fixed password transmitted from the access terminal 20, and makes access control.

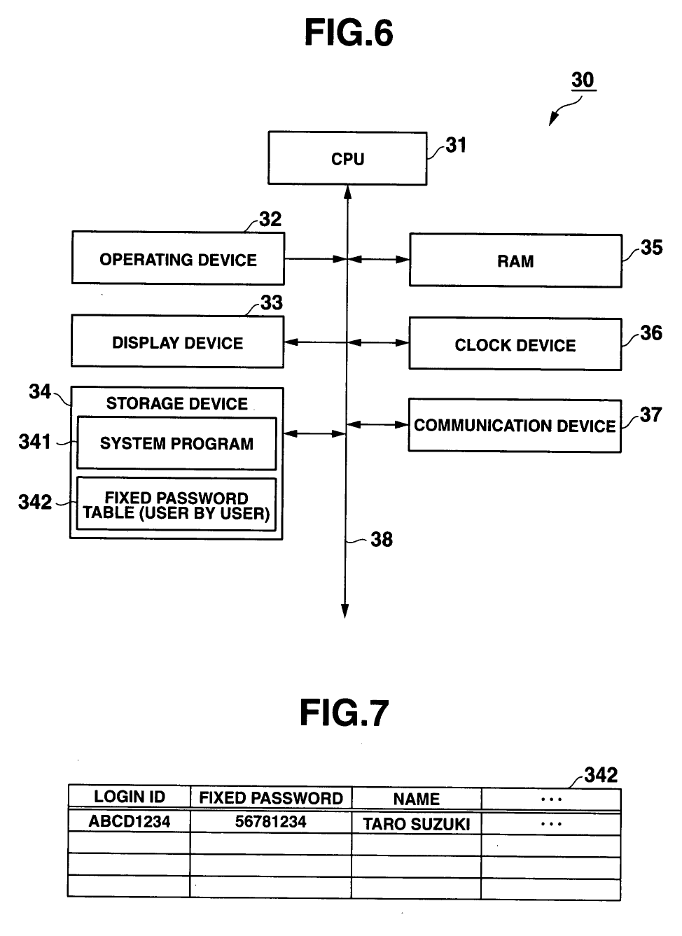

FIG. 6 is a block diagram showing an internal configuration of the RP authentication server 30. The RP authentication server 30 includes a CPU 31, an operating device 32, a display device 33, a storage device 34, a RAM 35, a clock device 36, a communication device 37 and the like, and constituent elements are connected via a bus line 38.

The CPU 31 executes a variety of processes under cooperation with a variety of programs stored in advance in the storage device 34 while the RAM 35 is used as a work area. The CPU 31 controls an operation of each of constituent elements that configure the RP authentication server 30.

The operating device 32 is equipped with a variety of input keys or the like, and outputs to the CPU 31 an input signal input by means of a user operation. The display device 33 includes a panel such as an LCD or ELD panel, and displays a variety of information based on a display signal from the CPU 31. The display device 33 may configure a touch panel integrally with the operating device 32.

The storage device 34 is equipped with a nonvolatile storage medium formed of a magnetic or an optical recording medium or a semiconductor memory, and stores a program required for an operation of the RP authentication server 30 and data relevant to execution of the program. The storage device 34, as shown in FIG. 6, stores a system program 341 and a user by user fixed password table 342.

The system program 341 is provided as a program for implementing basic functions as the RP authentication server 30. The CPU 31 implements read and write control of a variety of data to and from the storage device 34, display control of the display device 33, and input control of assigning execution of a predetermined function to a predetermined input key of the operating device 32, for example, under cooperation with the system program 341. The CPU 31 implements an information providing function for providing a screen, information and the like provided for authentication to the access terminal 20, under cooperation with the system program 341, and, for example, implements a function as a Web server.

Account information on users registered via the access terminal 20 is recorded in the user by user fixed password table 342. The account information includes personal information such as a login ID used at the time of login to this RP authentication server 30, crosscheck fixed passwords and user's names, and these items of information are registered in association with each other on a user by user basis.

FIG. 7 is a view showing an example of the user by user fixed password table 342 stored in the storage device 34. In the user by user fixed password table 342, information such as a login ID (ABCD1234), a crosscheck fixed password (56781234) and a name (Taro SUZUKI) is registered in association with each other on a user by user basis.

Upon receipt of a login ID or a fixed password transmitted from the access terminal 20, the CPU 31 refers to the user by user fixed password table 342, reads out the crosscheck fixed password associated with this login ID from the user by user fixed password table 342, compares/crosschecks the crosscheck fixed password and the fixed password transmitted from the access terminal 20, and makes access control based on this crosscheck result.

The RAM 35 is provided as a temporary storage area for programs, input or output data, and parameters read out from the storage device 34 in a variety of processes executed and controlled by means of the CPU 31.

The communication device 37 is provided as a network interface such as a modem, a terminal adaptor, or a LAN adaptor, and makes communication control of a variety of information exchanged with another device (such as access terminal 20) connected to the network N under the control of the CPU 31.

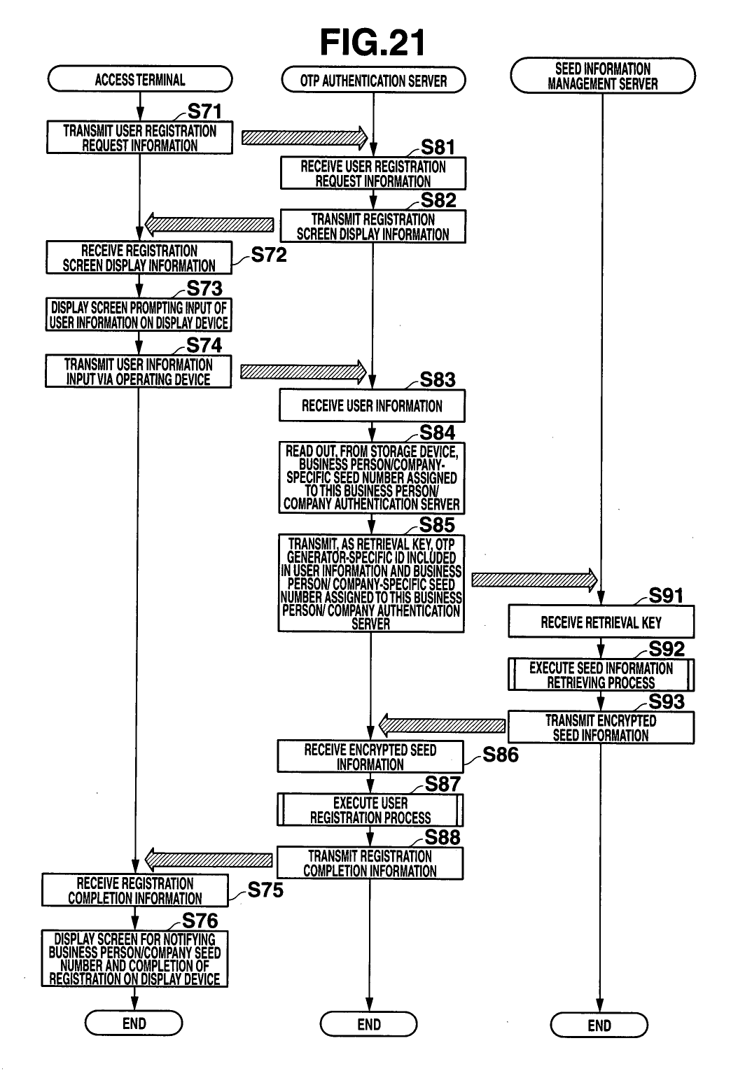

The OTP authentication server 40 is provided as an authentication server (OTP authentication site) that belongs to each business person/company. The OTP authentication server 40 determines whether or not a user of the access terminal 20 is a user registered by means of an OTP user registering process described layer (refer to FIG. 21) based on a login ID and an OTP transmitted from the access terminal 20, and makes an access control.

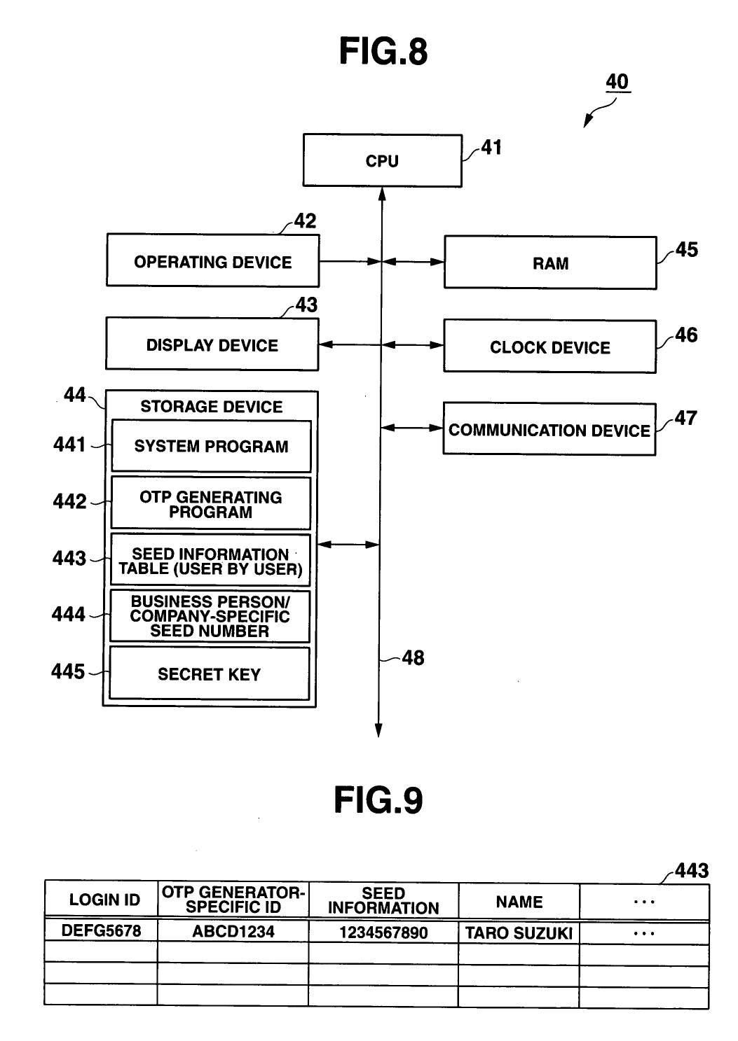

FIG. 8 is a block diagram showing an internal configuration of the OTP authentication server 40. The OTP authentication server 40 includes a CPU 41, an operating device 42, a display device 43, a storage device 44, a RAM 45, a clock device 46, a communication device 47 and the like, and constituent elements are connected via a bus line 48.

The CPU 41 executes a variety of processes under cooperation with a variety of programs stored in advance in the storage device 44 while the RAM 45 is used as a work area. The CPU 41 controls an operation of each of constituent elements that configure the OTP authentication server 40.

The operating device 42 is equipped with a variety of input keys or the like, and outputs to the CPU 41 an input signal input by means of a user operation. The display device 43 includes a panel such as an LCD or ELD panel, and displays a variety of information based on a display signal from the CPU 41. The display device 43 may configure a touch panel integrally with the operating device 42.

The storage device 44 is equipped with a nonvolatile storage medium formed of a magnetic or an optical recording medium or a semiconductor memory, and stores a program required for an operation of the OTP authentication server 40 and data relevant to execution of the program. As shown in FIG. 8, the storage device 44 stores a system program 441, an OTP generating program 442, a user by user seed information table 443, a business person/company-specific seed number 444, and a secret key 445.

The system program 441 is provided as a program for implementing basic functions as the OTP authentication server 40. The CPU 41 implements write and read control of a variety of data to and from the storage device 44, display control of the display device 43, input control of assigning execution of a predetermined function to a predetermined input key of the operating device 42, and the like, under cooperation with the system program 441. The CPU 41 implements an information providing function for providing a screen or information provided for authentication to the access terminal 20, under cooperation with the system program 441, and, for example, implements a function as a Web server.

The OTP generating program 442 is provided as a program for implementing functions relevant to generation of an OTP. The CPU 41 generates an OTP based on a predetermined algorithm using one item of seed information and the time information that is input from the clock device 46, under cooperation with the OTP generating program 442.

In the user by user seed information table 443, user information of users registered via the access terminal 20 is registered. The user information used here includes personal information such as a login ID of each user, an OTP generator-specific ID input at the time of a user registering process described later, seed information serving as a source of OTP generation, and user's names, and these items of information are registered in association with each other on a user by user basis.

FIG. 9 is a view showing an example of the user by user seed information table 443 stored in the storage device 44. In the user by user seed information table 443, information such as a login ID (DEFG5678), an OTP generator-specific ID (ABCD1234), seed information (1234567890), and a name (Taro SUZUKI) is registered in association with each other on a user by user basis.

Upon receipt of the login ID and the OTP transmitted from the access terminal 20, the CPU 41 refers to the user by user seed information table 443, reads out seed information corresponding to this login ID from the user by user seed information table 443, and generates a crosscheck OTP under cooperation with the OTP generating program 442 based on the thus read out seed information and the time information input from the clock device 46. The CPU 41 compares and crosschecks a crosscheck OTP and the OTP transmitted from the access terminal 20, and then, makes access control based on this crosscheck result.

The business person/company-specific seed number 444 is provided as a seed number (selection information) assigned in advance to each business person/company, and a specific seed number is assigned to each business person/company. The business person/company-specific seed number 444 corresponds to a seed number registered in the seed table 145 of each OTP generator 10. The seed information associated with a seed number of the seed table 145 that serves as a value equal to a numeric value indicated by the business person/company-specific seed number 444 is provided as a source of an OTP generated at the time of login to the OTP authentication server 40 of the business person/company-specific seed number 444.

The secret key 445 is provided as information corresponding to a “secret key” in a public key encryption scheme. The public key corresponding to the secret key 445 is stored in advance in the storage device 54 of the seed information management server 50. Upon receipt of the seed information, which has been encrypted by the public key, from the seed information management server 50, the CPU 41 decrypts the thus encrypted seed information by means of the secret key 445 that corresponds to the public key, associates the thus decrypted seed information with user information relevant to the seed information, and registers the associated seed information in the user by user seed information table 443.

The RAM 45 is provided as a temporary storage area for programs, input or output data, parameters or the like read out from the storage device 44 in a variety of processes executed and controlled by means of the CPU 41.

The clock device 46 measures a current time based on a clock signal produced by a quartz oscillator (not shown) for always generating a predetermined frequency signal, and then, outputs the thus measured time information to the CPU 41. The times to be clocked by means of the clock device 16 and the clock device 47 are assumed to be synchronized with each other.

The communication device 47 is provided as a network interface such as a modem, a terminal adaptor, or a LAN adaptor, and makes communication control of a variety of information exchanged with another device (such as access terminal 20 or seed information management server 50) connected to the network N under the control of the CPU 41.

The seed information management server 50 stores/manages a plurality of seed information stored in each OTP generator 10, and then, provides to the OTP authentication server 40 the seed information on a seed number that corresponds to each business person/company.

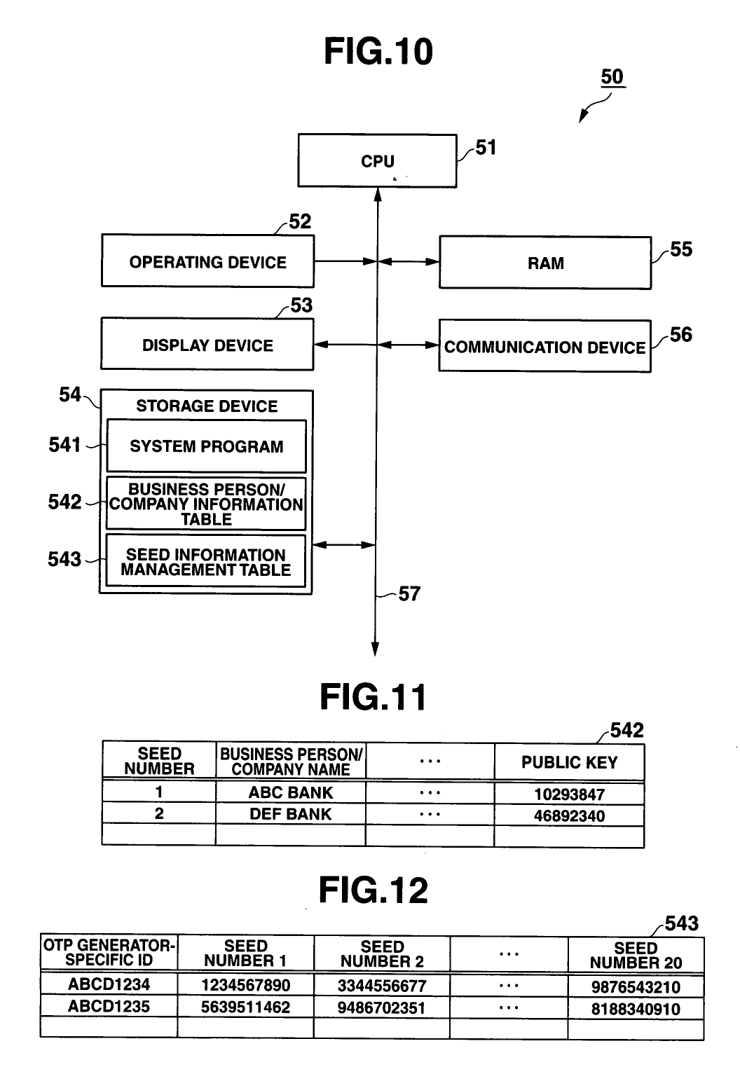

FIG. 10 is a block diagram showing an internal configuration of the seed information management server 50. The seed information management server 50 includes a CPU 51, an operating device 52, a display device 53, a storage device 54, a RAM 55, and a communication device 56, and constituent elements are connected via a bus line 57.

The CPU 51 executes a variety of processes under cooperation with a variety of programs stored in advance in the storage device 54 while the RAM 55 is used as a work area. The CPU 51 controls an operation of each of constituent elements that configure the seed information management server 50.

The operating device 52 is equipped with a variety of input keys or the like, and outputs to the CPU 51 an input signal input by means of a user operation. The display device 53 includes a panel such as a LCD or ELD panel, and displays a variety of information based on a display signal from the CPU 51. The display device 53 may configure a touch panel integrally with the operating device 52.

The storage device 54 is equipped with a nonvolatile storage medium formed of a magnetic or an optical recording medium or a semiconductor memory, and stores a program required for an operation of the seed information management server 50 and data relevant to execution of the program.

The storage device 54, as shown in FIG. 10, stores a system program 541, a business person/company information table 542, and a seed information management table 543.

The system program 541 is provided as a program for implementing basic functions as the seed information management server 50. The CPU 51 implements read and write control of a variety of data with respect to the storage device 54, display control of the display device 53, input control of assigning execution of a predetermined function to a predetermined input key of the operating device 52, for example, under cooperation with the system program 541.

In the business person/company information table 542, business person/company information concerning each business person/company relevant to the authentication system 100 is registered in association with each other for each business person/company. The business person/company information includes a seed number pre-assigned to each business person/company (business person/company-specific seed number), a business person/company name, a public key corresponding to a secret key 445 stored in the OTP authentication server 40 that belongs to each business person/company, and a domain name, a URL, and an IP address of the OTP authentication server 40, and these items of information are registered in association with each other for each business person/company.

FIG. 11 is a view showing an example of the business person/company information table 542 stored in the storage device 54. In the business person/company information table 542, a seed number, a business person/company-relevant information such as a business person/company name, and a public key are registered in association with each other for each business person/company. The registered seed number corresponds to a seed number of the seed table 145 stored in the ROM 14 of the OTP generator 10, and the OTP generated based on the seed information that corresponds to this seed number is used at the time of login to the OTP authentication server 40 of a business person/company that corresponds to the seed number.

In the seed information management table 543, the seed table 145 (seed information and seed number) and the OTP generator-specific ID 146 stored in the ROM 14 of each OTP generator 10 are registered in association with each other.

FIG. 12 is a view showing an example of the seed information management table 543 stored in the storage device 54. In the seed information management table 543, an OTP generator-specific ID, seed information, and a seed number, relevant to each OTP generator 10, are stored in association with each other.

The RAM 55 is provided as a temporary storage area for programs, input or output data, and parameters read out from the storage device 54 in a variety of processes executed and controlled by means of the CPU 51.

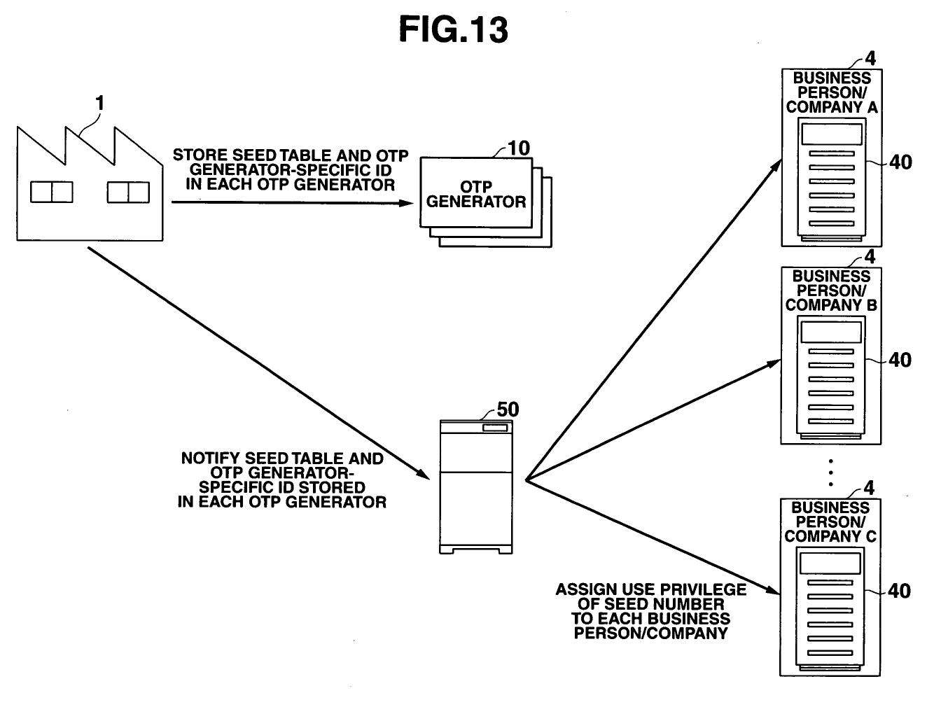

The communication device 56 is provided as a network interface such as a modem, a terminal adaptor, or a LAN adaptor, and makes communication control of a variety of information exchanged with another device (such as OTP authentication server 40) connected to the network N, under the control of the CPU 51. Environment setting of authentication system 100 Steps for setting an environment relevant to authentication in devices, each of which configures the authentication system 100, will be described with reference to FIGS. 13 to 17.

FIG. 13 is a view schematically showing steps for setting an environment relevant to authentication in the OTP generator 10, the OTP authentication server 40, and the seed information management server 50.

In an OTP generator manufacturer 1 for manufacturing the OTP generator 10, when the seed table 145 and the OTP generator-specific ID 146 are stored in the ROM 14 of each OTP generator 10 in a step for manufacturing the OTP generator 10, the seed table 145 and the OTP generator-specific ID 146 stored in each OTP generator 10 are associated with each other, and then, are notified to the seed information management server 50.

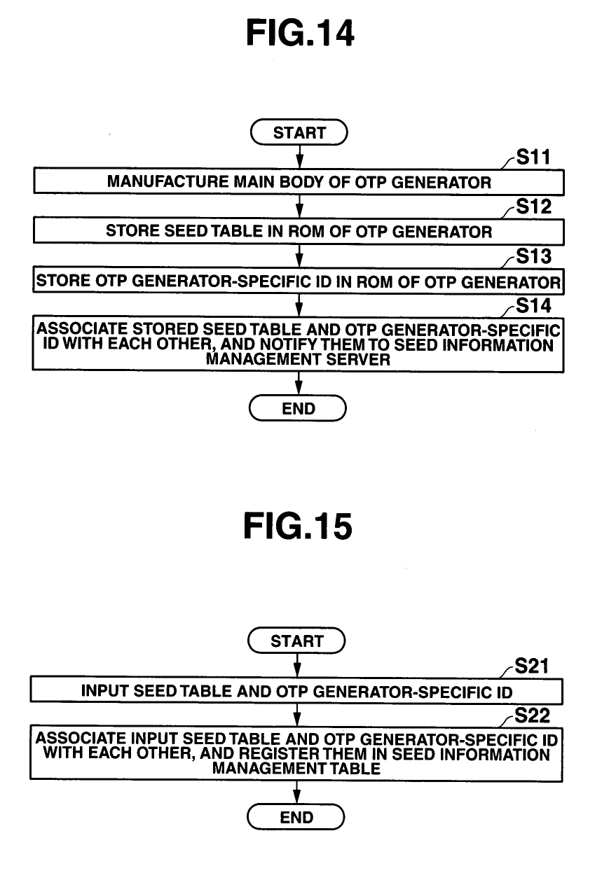

FIG. 14 is a flow chart showing procedures for executing a process for manufacturing an OTP generator by the OTP generator manufacturer 1.

When manufacture of an OTP generator main body is completed in a step for manufacturing an OTP generator (step S11), the seed table 145 is stored in the ROM 14 of the OTP generator 10 (step S12). In the seed table 145, a plurality of items of seed information are associated with a plurality of seed numbers, each of which corresponds to each one of the plurality of items of seed information. A specific ID such as a manufacturing number specific to the OTP generator 10 is stored as the OTP generator-specific ID 146 (step S13).

The seed table 145 and the OTP generator-specific ID 146 stored in steps S12 and S13 are associated with each other, and then, are notified to the seed information management server 50 (step S14). Then, this process terminates.

A plurality of items of seed information stored in one OTP generator 10 in step S12 are assumed to be different from each other. More preferably, these items of information should be different from any of a plurality of items of seed information stored in another OTP generator.

Turning to FIG. 13, in the seed information management server 50 having being notified of the seed table 145 and the OTP generator-specific ID 146 from the OTP generator manufacturer 1, the OTP generator-specific ID 146 and the seed table 145 are associated with each other, and then, are registered in the seed information management table 543 of the storage device 54.

FIG. 15 is a flow chart showing procedures for executing a process relevant to registration of the seed information management table 543 at the seed information management server 50. This process shows a process executed under cooperation between the CPU 51 and a variety of programs that are stored in the storage device 54.

When the seed table 145 and the OTP generator-specific ID 146 are notified (input) from the OTP generator manufacturer 1 via the operating device 52, the communication device 56 or the like (step S21), the OTP generator-specific ID 146 and the seed table 145 are associated with each other, and then, the seed information management table 543 is stored in the storage device 54 of the seed information management server 50 (step S22). Then, this process terminates.

Turning to FIG. 13, when a privilege of using a seed number is assigned to each of business person/company 4 (business persons/companies A to C), the seed information management server 50 associates business person/company-relevant information relevant to a business person/company such as a seed number, a business person/company name assigned to the seed number, a domain name of the OTP authentication server 40, and an IP address with a public key that corresponds to a secret key 445 stored in the OTP authentication server 40 that belongs to the business person/company, and then, registers the associated information in the business person/company information table 542.

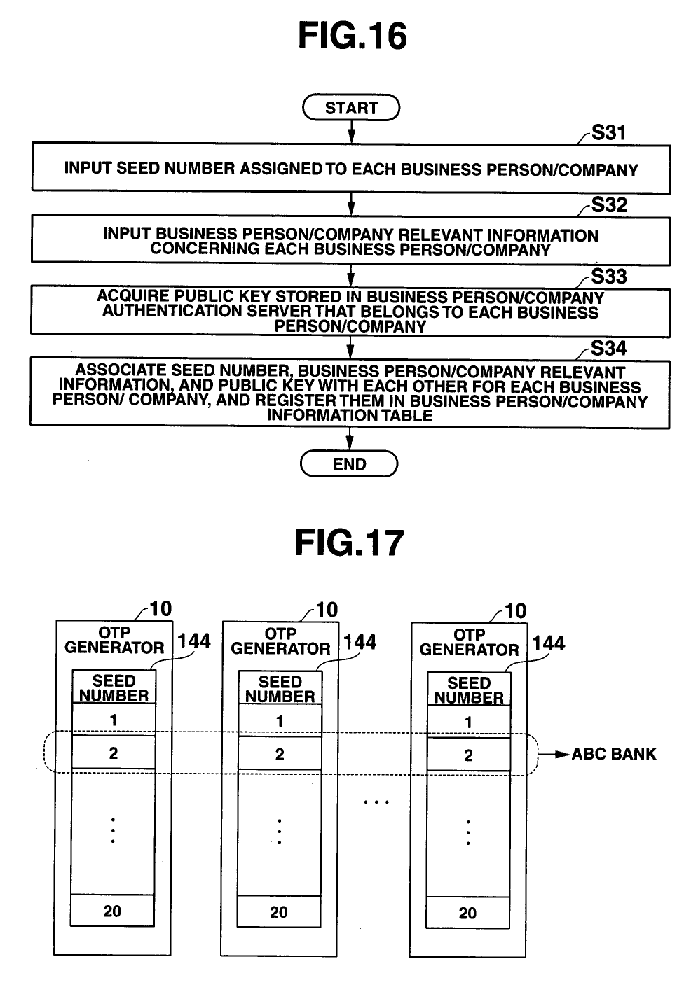

FIG. 16 is a flow chart showing procedures for executing a process relevant to registration of the business person/company information table 542 at the seed information management server 50. This process shows a process executed under cooperation between the CPU 51 and a variety of programs stored in the storage device 54.

The seed numbers assigned to business persons/companies are notified (input) via the operating device 52, the communication device 56 or the like (step S31). After relevant information relevant to business persons/companies has been input (step S32), and a public key stored in the OTP authentication server 40 that belongs to each business person/company is input (step S33), the input seed numbers, public keys, and business person/company-relevant information are associated with each other for each business person/company, and then registered in the business person/company information table 542 of the storage device 54 (step S34). Then, this process terminates.

On the other hand, the OTP authentication server 40 that belongs to a business person/company to which a seed number has been assigned, stores the seed number assigned to the business person/company as the business person/company-specific seed number 444 in the storage device 54.

As described above, the seed numbers corresponding to business persons/companies are defined for the seed information management server 50 (business person information table 542) and the OTP authentication server 40, whereby the seed numbers stored in the OTP generators 10 are defined as those for specific business persons/companies. For example, when a seed number “2” is assigned to a business person/company name “ABC bank”, and is stored in association with the business person/company information table 542, the seed number “2” stored in each OTP generator 10 is defined as that for the “ABC bank”, as shown in FIG. 17. In other words, an OTP generated based on the seed information that corresponds to the seed number “2” is used at the time of access to the OTP authentication server 40 that belongs to the “ABC bank”. Operation made at the time of user registration Referring to FIG. 18, a description will be given with respect to an operation made at the time of registration of user information in the RP authentication server 30.

FIG. 18 is a ladder chart showing procedures for executing a process (RP user registering process) relevant to registration of user information in the RP authentication server 30. In the figure, each of the processes in steps S41 to S46 shows a process to be executed under cooperation with the CPU 21 of the access terminal 20 and a variety of programs stored in the storage device 24. Each of the processes in steps S51 to S55 shows a process to be executed under cooperation between the CPU 31 of the RP authentication server 30 and a variety of programs stored in the storage device 34.

At the access terminal 20, instruction information for registering user information (user registration request information) is transmitted to a specific RP authentication server 30 in accordance with a specific user operation via the operating device 22 (step S41).

When the RP authentication server 30 receives the user registration request information from the access terminal 20 (step S51), instruction information for instructing display of a screen that prompts input of user information including a name, a login ID, a fixed password and the like of a user who makes registration (registration screen display information) is transmitted to the access terminal 20 (step S52).

When the access terminal 20 receives the registration screen display information from the RP authentication server 30 (step S42), a screen that prompts input of user information is displayed on the display device 13, based on this registration screen display information (step S43). Then, when a name, a login ID, a fixed password and the like of the user are input via the operating device 12, based on the screen displayed on the display device 13, the thus input user information is transmitted to the RP authentication server 30 (step S44).

When the RP authentication server 30 receives the user information from the access terminal 20 (step S53), a variety of information included in this user information is registered in association with the user by user fixed password table 342 (step S54), and then, instruction information for instructing display of completion of registration (registration completion information) is transmitted to the access terminal 20 (step S55). Then, the process of the RP authentication server 30 terminates.

When the access terminal 20 receives the registration completion information from the RP authentication server 30 (step S45), a screen for notifying a business person/company-specific seed number and completion of registration to the display device 13 is displayed based on this registration completion information (step S46). Then, the process of the access terminal 20 terminates.

The user information is registered in the RP authentication server 30 in accordance with the process described above. Subsequently, the user relevant to this user information is capable of login from the access terminal 20 to the RP authentication server 30.

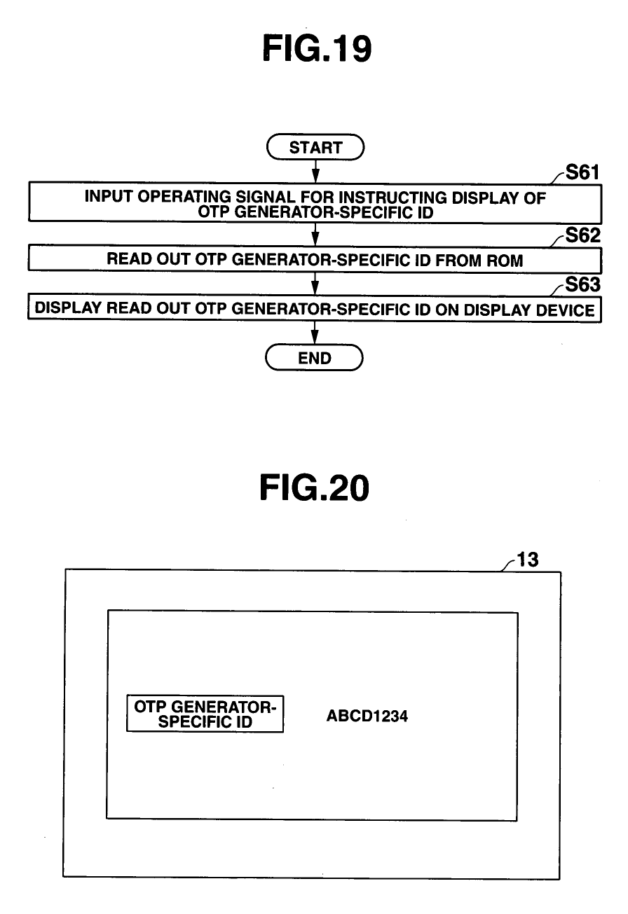

Referring to FIGS. 19 to 23, a description will be given with respect to an operation made at the time of registration of user information in the OTP authentication server 40.

FIG. 19 is a flow chart showing a process to be executed by means of the OTP generator 10 at the time of registration of user information. This process shows a process to be executed under cooperation between the CPU 11 and a variety of programs stored in the ROM 14.

When an operating signal instructing display of an OTP generator-specific ID of the OTP generator 10 is input via the operating device 12 (step S61), the OTP generator-specific ID 146 stored in the ROM 14 is read out (step S62). The read out OTP generator-specific ID 146 is displayed on the display device 13, as shown in FIG. 20 (step S63), and then, this process is terminated.

In the present embodiment described above, the OTP generator-specific ID 146 is output to the display device 13. Without being limited to this case, however, in the case where the access terminal 20 is connected to the I/F device 18, the ID may be transmitted to the access terminal 20 via the I/F device 18.

FIG. 21 is a ladder chart showing procedures for executing a process (OTP user registering process) relevant to registration of user information in the OTP authentication server 40. Each of the processes in steps S71 to S76 shows a process to be executed under cooperation between the CPU 21 of the access terminal 20 and a variety of programs stored in the storage device 24. Each of the processes in steps S81 to S88 shows a process to be executed under cooperation between the CPU 41 of the OTP authentication server 40 and a variety of programs stored in the storage device 44. Each of the processes in steps S91 to S93 shows a process to be executed under cooperation between the CPU 51 of the seed information management server 50 and a variety of programs stored in the storage device 54.

At the access terminal 20, instruction information for making registration of user information (user registration request information) is transmitted to a specific OTP authentication server 40 in accordance with a predetermined user operation via the operating device 22 (step S71).

When the OTP authentication server 40 receives user registration request information from the access terminal 20 (step S81), instruction information for instructing display of a screen that prompts input of user information including a user name, a login ID (user ID), an OTP generator-specific ID (registration screen display information) is transmitted to the access terminal 20 (step S82).

When the access terminal 20 receives the registration screen display information from the OTP authentication server 40 (step S72), a screen prompting input of user information is displayed on the display device 13, based on this registration screen display information (step S73). When the user information such as a user name, a user ID, and an OTP generator-specific ID is input via the operating device 12 based on the screen displayed on the display device 13, the thus input user information is transmitted to the OTP authentication server 40 (step S74). While it is assumed that an OTP generator-specific ID displayed on the display device 13 of the OTP generator 10 is input in the process of FIG. 19, an input mode thereof is not restricted. It may be input from the user via the operating device 22. In the case where the OTP generator 10 is connected to the I/F device 27, the OTP generator-specific ID transmitted from the OTP generator 10 may be input.

When the OTP authentication server 40 receives the user information from the access terminal 20 (step S83), a business person/company-specific seed number 444 assigned to this OTP authentication server 40 is read out from the storage device 44 (step S84). Then, the OTP generator-specific ID included in the user information and the read out business person/company-specific seed number are transmitted as a retrieval key to the seed information management server 50 (step S85).

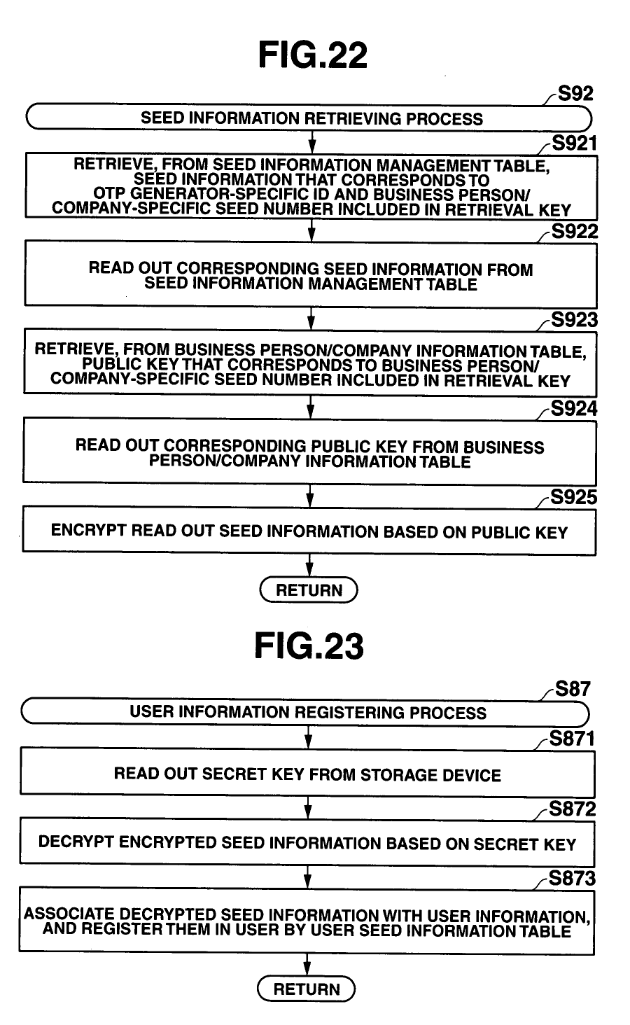

When the seed information management server 50 receives the retrieval key from the OTP authentication server 40 (step S91), the current routine moves to a seed information retrieving process (step S92). Hereinafter, the seed information retrieving process of step S92 will be described with reference to FIG. 22.

FIG. 22 is a flow chart showing procedures for executing a seed information retrieving process.

The seed information corresponding to an OTP generator-specific ID and a business person/company-specific seed number included in a retrieval key is retrieved from the seed information management table 543 (step S921), and then, the corresponding seed information is read out from the seed information management table 543 (step S922). After the public key corresponding to the business person/company-specific seed number included in the retrieval key has been retrieved from the business person/company information table 542 (step S923), and the corresponding public key is read out from the business person/company information table 542 (step S924), the seed information read out in step S922 is encrypted based on this public key (step S925), and then, the current routine moves to step S93.

Turning to FIG. 21, the seed information encrypted in step S925 (hereinafter, referred to as encrypted seed information) is transmitted to the OTP authentication server 40 having transmitted this retrieval key (step S93), and then, the process of the seed information management server 50 terminates.

In this way, security relevant to seed information can be improved because the encrypted seed information is transmitted to the OTP authentication server 40.

When the OTP authentication server 40 receives the encrypted seed information from the seed information management server 50 (step S86), the current routine moves to a user information registering process (step S87). Hereinafter, the user information registering process of step S87 will be described with reference to FIG. 23.

FIG. 23 is a flow chart showing procedures for executing the user information registering process.

The secret key 445 stored in the storage device 44 is read out (step S871), and then, the encrypted seed information is decrypted based on the secret key 445 to obtain the decrypted seed information (step S872). Then, the decrypted seed information is registered in the user by user seed information table 443 in association with the user information received in step S83 (step S873), and then, the current routine moves to step S88.

Turning to FIG. 21, a business person/company-specific seed number 44 assigned to this OTP authentication server 40 and instruction information for instructing display of completion of registration (registration completion information) are transmitted to the access terminal 20 (step S88), and then, the process of the OTP authentication server 40 terminates.

When the access terminal 20 receives registration completion information from the OTP authentication server 40 (step S75), a screen for notifying a business person/company-specific seed number and completion of registration is displayed on the display device 13 based on this registration completion information (step S77). Then, the process of the access terminal 20 terminates.

The user information is registered in the OTP authentication server 40 in accordance with the process described above. Subsequently, the user relevant to this user information is capable of login from the access terminal 20 to the OTP authentication server 40.

As described above, the account information management table 171 is stored in the storage device 17 of the OTP generator 10. The user can input to the CPU 11, via the operating device 12 or the like, an instruction for registering in the account information management table 171 the account information that is formed on a site name, a URL, a login ID, a fixed password, or an OTP of the RP authentication server 30 or the OTP authentication server 40 that serves as a connection destination site. The account information management table 171 has a so called password bank function. The account information registered in the account information management table 171 is used at the time of login to the OTP authentication server 40 described later, thereby making it possible to improve convenience of connection to the RP authentication server 30 or the OTP authentication server 40.

FIG. 24 is a flow chart showing procedures for executing a process (account information managing process) relevant to registration into the account information management table 171. This process shows a process to be executed under cooperation between the CPU 11 and a variety of programs stored in the ROM 14.

When an instruction signal for instructing registration of account information is input by means of a predetermined user operation via the operating device 12 (step S101), a screen prompting selection of a fixed password authentication scheme or an OTP authentication scheme is displayed (step S102).

When an instruction signal for instructing selection of the fixed password authentication scheme is input (step S103: RP), a screen prompting inputs of a URL, a login ID, and a fixed password of a connection destination site is displayed on the display device 13 (step S104).

Subsequently, when an URL, a login ID, and a fixed password are input, and then, the relevant instruction signal is input, by means of a predetermined user operation via the operating device 12 (step S105), a variety of the thus input information are associated with each other, and then, are registered in the account information management table 171 (step S106). Then, this process is terminated.

When an instruction signal for instructing selection of the OTP authentication scheme is input in step S103 (step S103: OTP), all of the seed numbers registered in the seed table 145 are read out (step S107). All of the thus read out seed numbers are displayed on the display device 13 in a mode such that they can be selected via the operating device 12 (step S108).

When a specific seed number is selected, and then, the relevant instruction signal is input, by means of the predetermined user operation via the operating device 12 (step S109), a screen prompting inputs of a URL and a login ID of a connection destination site is then displayed on the display device 13 (step S110).

When the URL and login ID are input, and then, the relevant instruction signal is input, by means of the specific user operation via the operating device 12 (step S111), the thus input URL and login ID and the seed number selected in step S109 are registered in the account information management table 171 in association with each other (step S112). Then, this process is terminated.

In the present embodiment described above, one seed number is selected from all the seed numbers registered in the seed table 145. However, the invention is not limited to this case. For example, a business person/company-specific seed number displayed on the display device 13 of the OTP generator 10 in step S76 of the user registering process described above is assigned as a seed number of the OTP generator 10, whereby these seed number and account information may be registered in the account information management table 171 in association with each other.

In addition, while the present embodiment has described that account information is input via the operating device 12, a mode for inputting account information is not limited thereto. For example, it may be input from an external terminal device such as the access terminal 20 via the I/F device 18.

### Operation at the Time of Login

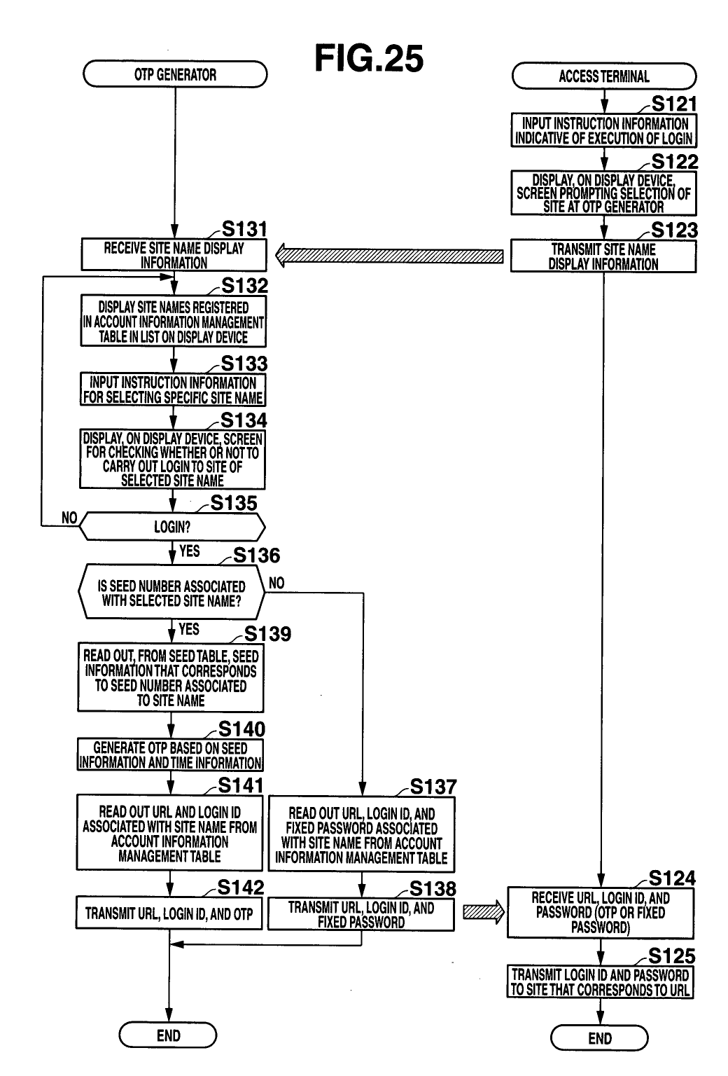

Referring to FIGS. 25 to 28, a description will be given with respect to an operation made at the time of carrying out login from the access terminal 20 to the RP authentication server 30 or the OTP authentication server 40. It is assumed that the OTP generator 10 and the access terminal 20 are connected to each other via the I/F device 18 and the I/F device 27.

FIG. 25 is a ladder chart showing procedures executed by means of the OTP generator 10 and the access terminal 20 at the time of login to the RP authentication server 30 or the OTP authentication server 40. Each of the processes in steps S121 to S125 shows a process to be executed under cooperation between the CPU 21 of the access terminal 20 and a variety of programs stored in the storage device 24. Each of the processes in steps S131 to S142 shows a process to be executed under cooperation between the CPU 11 of the OTP generator 10 and a variety of programs stored in the ROM 14.

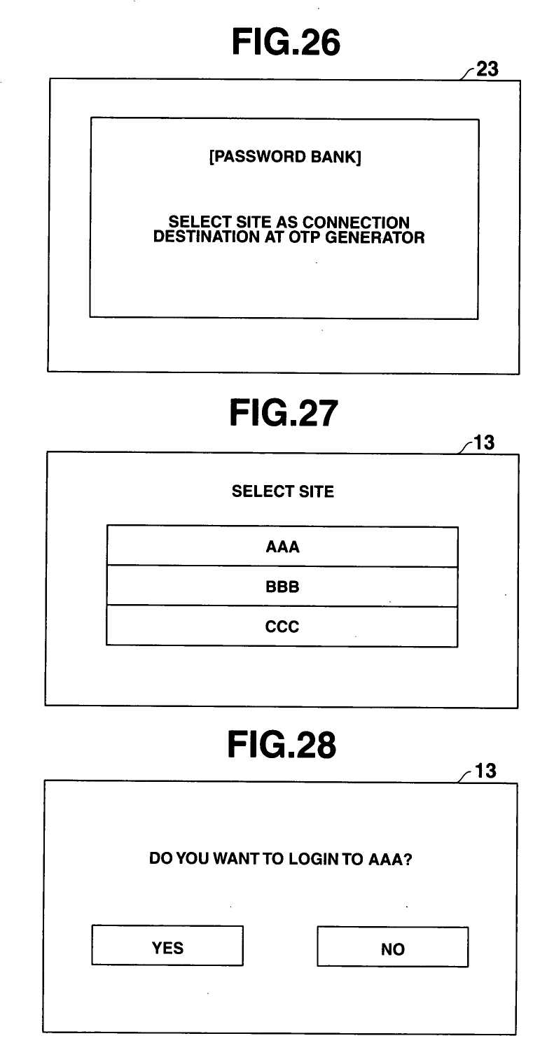

At the access terminal 20, when instruction information for carrying out login is input by means of a predetermined user operation via the operating device 22 (step S121), a screen prompting selection of a connection destination site at the OTP generator 10 (refer to FIG. 26) is displayed on the display device 23 (step S122). Instruction information for displaying a list of all the site names registered in the account information management table 171 (site name display information) is transmitted to the OTP generator 10 (step S123).

When the OTP generator 10 receives the site name display information from the access terminal 20 (step S131), all the site names registered in the account information management table 171 are displayed on the display device 13 in a list in a selectable mode (step S132).

FIG. 27 is a view showing an example of site names displayed on the display device 13 in step S132. A user can select a desired site name from among the site names “AAA”, “BBB”, and “CCC”, via the operating device 12. An instruction signal for instructing the thus selected site name is input to the CPU 11.

When a specific site name is selected (for example, “AAA”), and then, the relevant instruction signal is input, by means of a predetermined user operation via the operating device 12 (step S133), a screen for verifying whether or not login is carried out for an authentication site of the thus selected site name (refer to FIG. 28) is displayed on the display device 13 (step S134). In the case where instruction information indicative of disabling login has been input via the operating device 12 (step S135: No), the current routine returns to step S132 in which all the site names registered in the account information management table 171 are displayed again in a list on the display device 13.

In the case where instruction information indicating that login is carried out has been input via the operating device 12 in step S135 (step S135: Yes), the account information management table 172 is referred to, and then, it is determined whether or not a seed number is registered in association with the selected site name (step S136).

In the case where it is determined that no seed number is registered in association with the selected site name, i.e., a fixed password is registered in association therewith, in step S136 (step S136: No), the URL, login ID, and fixed password associated with the thus selected site name are read out from the account information management table 171 (step S137). Then, a variety of the thus read out information are transmitted to the access terminal 20 (step S138), and then, the process of the OTP generator 10 terminates.

In the case where it is determined that the seed number is registered in association with the selected site name in step S136 (step S136: Yes), the seed information corresponding to the seed number associated with the thus selected site name is read out from the seed table 145 (step S139). Then, an OTP is generated based on the read out seed information and the time information input from the clock device 16 (step S140).

The URL and login ID associated with the selected site name are read out from the account information management table 171 (step S141), and then, a variety of the read out information is transmitted to the access terminal 20 together with the OTP generated in step S140 (step S142). Then, the process of the OTP generator 10 terminates.

When the access terminal 20 receives from the OTP generator 10 the URL, the login ID, and the password (fixed password or OTP) of an authentication site that serves as a connection destination (step S124), the login ID and the password (fixed password or OTP) are transmitted to this URL, whereby login is carried out for an authentication site targeted for connection (step S125). Then, the process of the access terminal 20 terminates.

As described above, according to the present embodiment, an OTP or a fixed password can be transmitted to an authentication site in response to an authentication scheme of the authentication site (RP authentication server 30 or OTP authentication server 40) that serves as a connection destination, thus making it possible to improve convenience relevant to connection to the authentication site.

Other embodiments of the identification information output device according to the present invention will be described. The same portions as those of the first embodiment will be indicated in the same reference numerals and their detailed description will be omitted.

### Second Embodiment

Now, the second embodiment of the present invention will be described below.

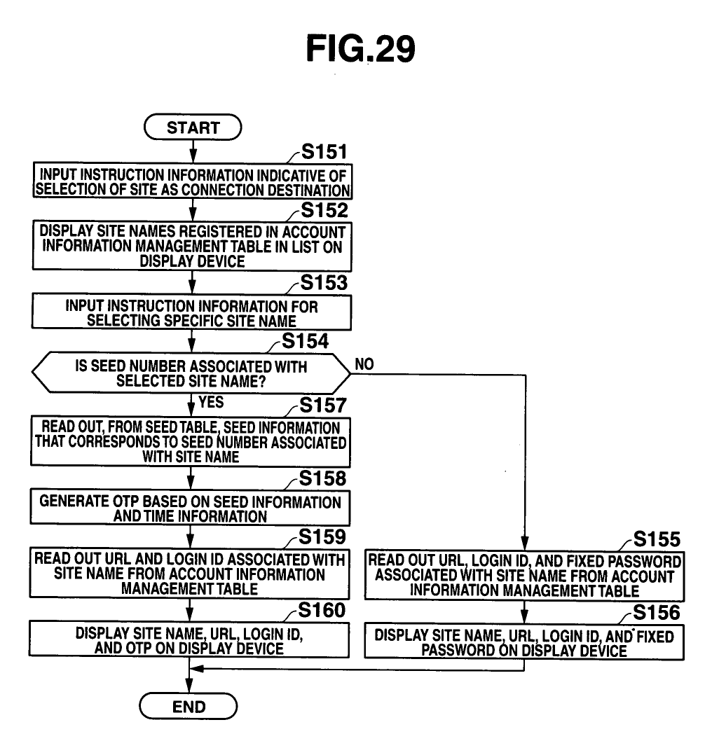

Referring to FIGS. 29 to 32, a description will be given with respect to an operation made at the time of carrying out login from the access terminal 20 to the RP authentication server 30 or the OTP authentication server 40. In the present embodiment, it is assumed that the OTP generator 10 and the access terminal 20 are not connected to each other via the I/F device 18 or I/F device 27, and the OTP generator 10 and the access terminal 20 configure the authentication system 100 in a state in which they are independent of each other.

FIG. 29 is a flow chart showing procedures executed by means of the OTP generator 10 at the time of login to the RP authentication server 30 or the OTP authentication server 40. This process shows a process to be executed under cooperation between the CPU 11 and a variety of programs stored in the ROM 14.

When an instruction signal for instructing selection of a connection destination site is input by means of a predetermined user operation via the operating device 12 (step S151), all the site names registered in the account information management table 171 are displayed in a list on the display device 13 in a selectable mode (step S152). The screen displayed here is identical to that of FIG. 27 described above. A detailed description thereof is omitted here.

Subsequently, when a specific site name is selected, and then, the relevant instruction signal is input by means of the predetermined user operation via the operating device 12 (step S153), the account information management table 171 is referred to, and then, it is determined whether or not a seed number is registered in association with the selected site name (step S154).

In the case where it is determined that no seed number is registered in association with the selected site name, i.e., a fixed password is registered in association therewith, in step S154 (step S154: No), the URL, login ID, and fixed password associated with the thus selected site name are read out from the account information management table 171 (step S155). A variety of the read out information are displayed on the display device 13 together with the selected site name (step S156), and then, this process terminates.

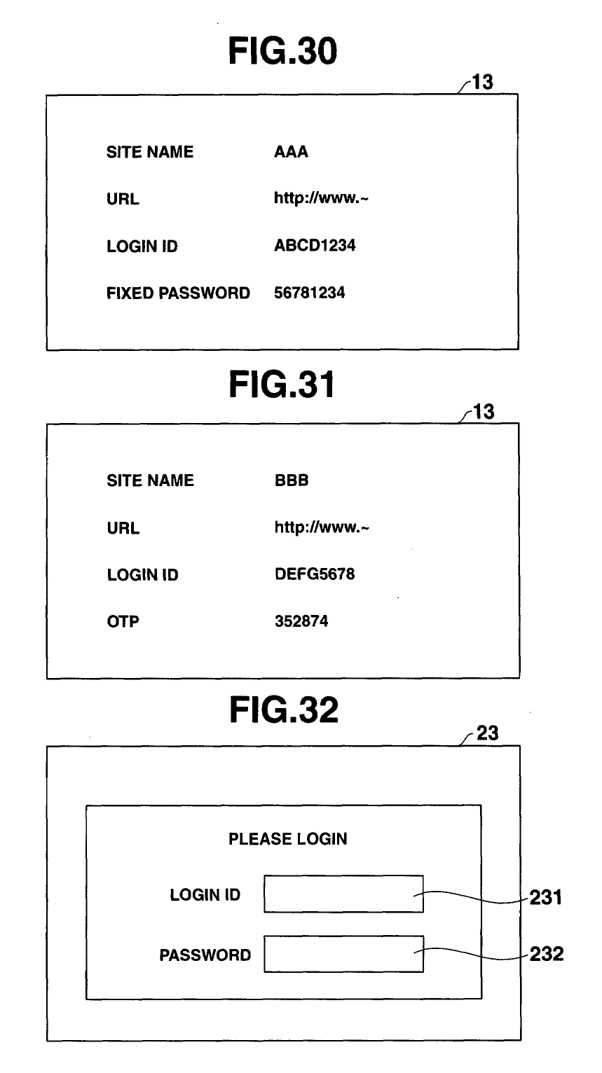

FIG. 30 is a view showing an example of the site name, URL, login ID, and fixed password displayed on the display device 13 in step S156. The figure shows a display screen in the case where “AAA” has been selected from among the site names registered in the account information management table 171.

In the case where it is determined that the seed number is registered in association with the selected site name in step S154 (step S154: Yes), the seed information corresponding to the seed number associated with the thus selected site name is read from the seed table 145 (step S157). Then, an OTP is generated based on the seed information and the clock information input from the clock device 16 (step S158).

Subsequently, the URL and login ID associated with the selected site name are read out from the account information management table 171 (step S159), and a variety of the read out information is displayed on the display device 13 together with the selected site name and the OTP generated in step S139 (step S160). Then, this process terminates.

FIG. 31 is a view showing an example of the site name, URL, login ID, and OTP displayed on the display device 13. The figure shows a display screen in the case where “BBB” has been selected from among the site names registered in the account information management table 171.

As shown in FIG. 30 or 31, when a user inputs the URL displayed on the display device 13 of the OTP generator 10 to the access terminal 20 via the operating device 22, connection is made to an authentication site that corresponds to this URL. Then, as shown in FIG. 32, a login screen for the site is displayed on the display device 23 of the access terminal 20. Further, the login ID and password (fixed password or OTP) displayed on the display device 13 of the OTP generator 10 are input via the operating device 22 to input areas 231 and 232 of the login ID and password included in this login screen, and then transmitted, whereby login is carried out for an authentication site targeted for connection.

As has been described above, according to the second embodiment, an OTP or a fixed password can be displayed in accordance with an authentication scheme of an authentication site (RP authentication server 30 or OTP authentication server 450) that serves as a connection destination. Thus, a password according to the connection destination can be notified to a user and this password can be transmitted to the authentication site. Therefore, convenience relevant to connection to the authentication site can be improved.

### Third Embodiment

Now, the third embodiment of the present invention will be described here.

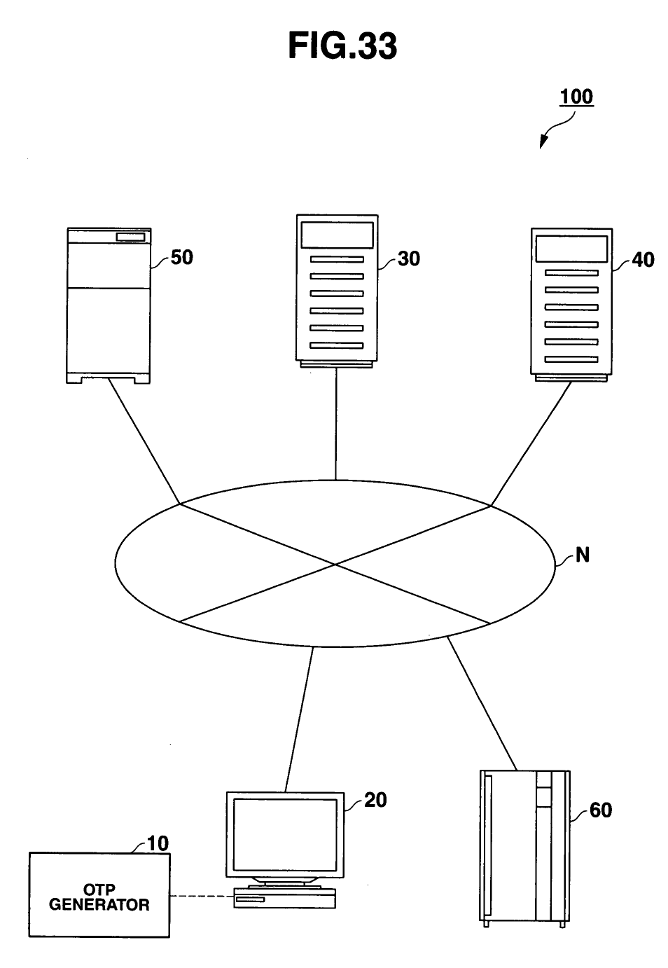

A configuration of the authentication system 100 in the present embodiment will be described with reference to FIG. 33.

As shown in FIG. 33, the authentication system 100 according to the present embodiment has a login management server 60 in addition to constituent elements of the authentication system 100 according to the first embodiment.

The login management server 60 has a password bank function of storing/managing an account information management table 644, and then, provides to the access terminal 20 the account information relevant to a specific site name registered in the account information management table 644, in response to a request from the access terminal 20.

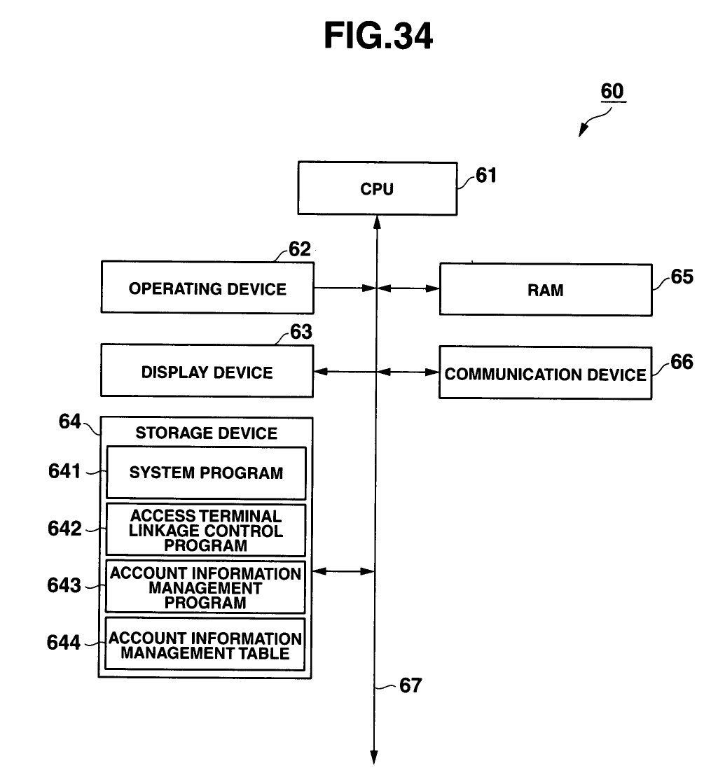

FIG. 34 is a block diagram showing an internal configuration of the login management server 60. As shown in FIG. 34, the login management server 60 includes a CPU 61, an operating device 62, a display device 63, a storage device 64, a RAM 65, and a communication device 66, and constituent elements are connected via a bus line 67.

The CPU 61 executes a variety of processes under cooperation with a variety of programs stored in advance in the storage device while the RAM 65 is used as a work area. The CPU 61 controls an operation of each of constituent elements that configure the login management server 60.

The operating device 62 is equipped with a variety of input keys, and outputs to the CPU 61 an input signal input by means of a user operation. The display device 63 includes a panel such as an LCD or ELD panel, and displays a variety of information based on a display signal from the CPU 21. The display device 63 may configure a touch panel integrally with the operating device 62.

The storage device 64 is equipped with a nonvolatile storage medium formed of a magnetic or an optical recording medium or a semiconductor memory, and stores a program required for an operation of the login management server 60 and data relevant to execution of the program. The storage device 64, as shown in FIG. 34, stores a system program 641, an access terminal linkage control program 642, an account information management program 643, and the account information management table 644.

The system program 641 is provided as a program for implementing basic functions as the login management server 60. The CPU 61 implements read/write control of a variety of data with respect to the storage device 64, display control of the display device 63, and input control of assigning execution of a predetermined function to a predetermined input key of the operating device 62, and the like, under cooperation with the system program 641.

The access terminal linkage control program 642 is provided as a program for implementing functions relevant to linkage with the access terminal 20. Specifically, under cooperation with the CPU 61, a variety of programs such as the account information management program 643 are executed in accordance with a variety of instruction information transmitted from the access terminal 20 connected via the communication device 66. Then, operations such as reading out the account information registered in the account information management table 644 or registering the account information are implemented.

The account information management program 643 is provided as a program for implementing functions relevant to registration/management of the account information management table 644. The CPU 61 executes a process that is similar to the account information managing process described above (refer to FIG. 24) under cooperation with the account information management program 643.

In the account information management table 644, a site name serving as an access destination and a variety of information required at the time of login to an authentication site of this site name are registered in association with each other. The account information management table 644 has a table structure (refer to FIG. 4) similar to that of the account information management table 171 described above. Thus, a detailed description thereof is omitted here. With respect to registration of a variety of information into the account information management table 644, it is assumed that a process similar to the account information managing process described above (refer to FIG. 24) is executed under cooperation with the CPU 61 and the account information management program 643. In addition, it is assumed that instruction signals in this process are input from the operating device 22 of the access terminal 20 via the network N.

The RAM 65 is provided as a temporary storage area for programs, input or output data, parameters or the like, read out from the storage device 64, in a variety of processes executed and controlled by means of the CPU 61.

The communication device 66 is provided as a network interface such as a modem, a terminal adaptor, or a LAN adaptor, and then, makes communication control of a variety of information exchanged with another device (such as access terminal 20) connected to the network N, under the control of the CPU 61.

It is assumed that the OTP generator 10 according to the present embodiment does not store the account information management table 171 in the storage device 17. This OTP generator may store the account information management table 171 without being limited thereto.

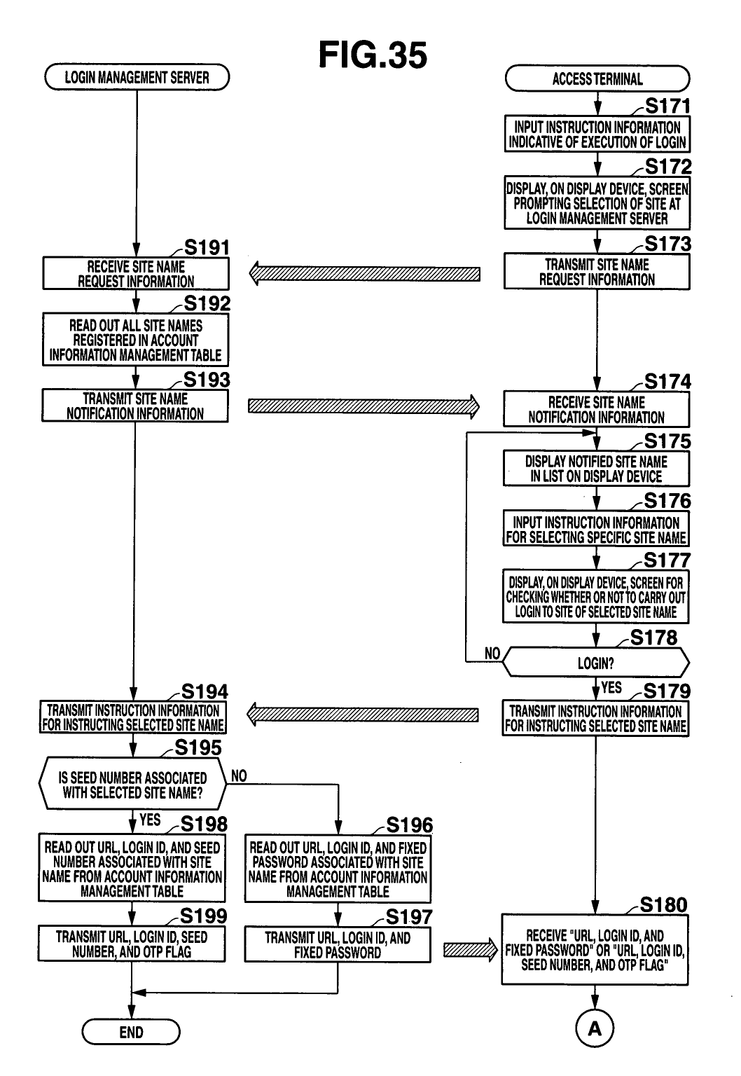

Referring to FIGS. 35 to 39, a description will be given with respect to an operation made at the time of carrying out login from the access terminal 20 to the RP authentication server 30 or the OTP authentication server 40. In the present embodiment, it is assumed that the OTP generator 10 and the access terminal 20 are connected to each other via the I/F device 18 and the I/F device 27.

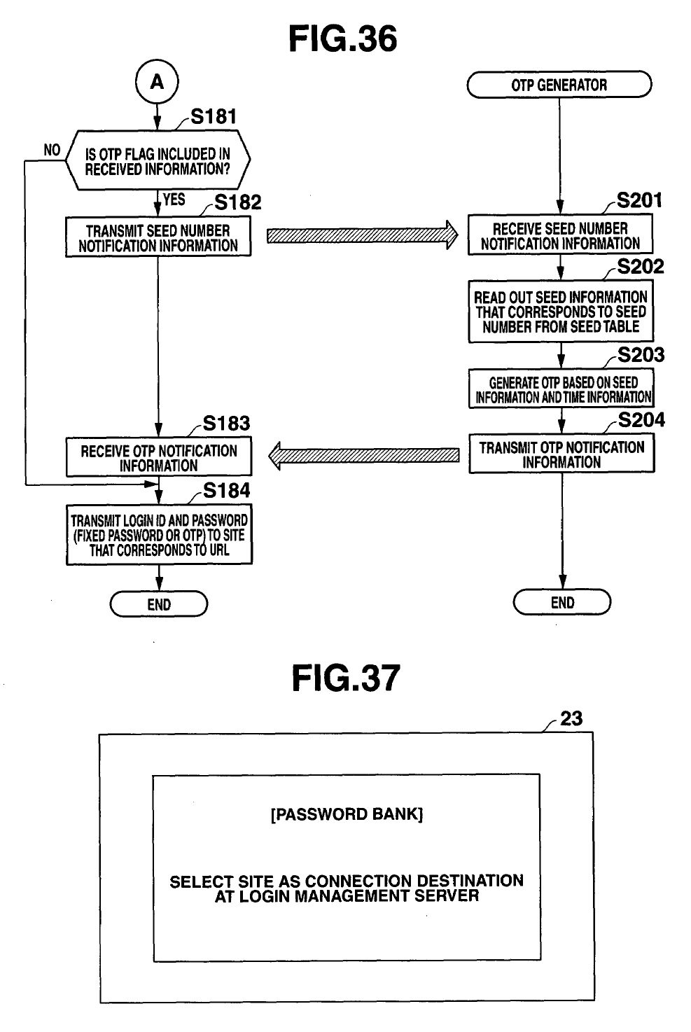

FIGS. 35 and 36 are ladder charts showing procedures executed by means of the OTP generator 10, the access terminal 20, and the login management server 60 at the time of login to the RP authentication server 30 or the OTP authentication server 40. In the figures, each of the processes in steps S171 to S184 shows a process to be executed under cooperation with the CPU 21 of the access terminal 20 and a variety of programs stored in the storage device 24. Each of the processes in steps S191 to S199 shows a process to be executed under cooperation with the CPU 61 of the login management server 60 and a variety of programs stored in the storage device 64. Each of the processes in steps S201 to S204 shows a process to be executed under cooperation with the CPU 11 of the OTP generator 10 and a variety of programs stored in the ROM 14.

At the access terminal 20, when instruction information indicative of carrying out login has been input by means of a predetermined user operation via the operating device 22 (step S171), a screen (refer to FIG. 37) for prompting selection of a connection destination site at the login management server 60 is displayed on the display device 23 (step S172). Then, instruction information for requesting all the site names registered in the account information management table 644 (site name request information) is transmitted to the login management server 60 (step S173).

When the login management server 60 receives the site name request information from the access terminal 20 (step S191), all the site names registered in the account information management table 644 are read out (step S192), and then, instruction information for notifying the read out site names (site name notification information) is transmitted to the access terminal 20 (step S193).

When the access terminal 20 receives the site name notification information from the login management server 60 (step S174), the site names notified in accordance with this site name notification information are displayed in a list on the display device 13 in a selectable mode via the operating device 12 (step S175).

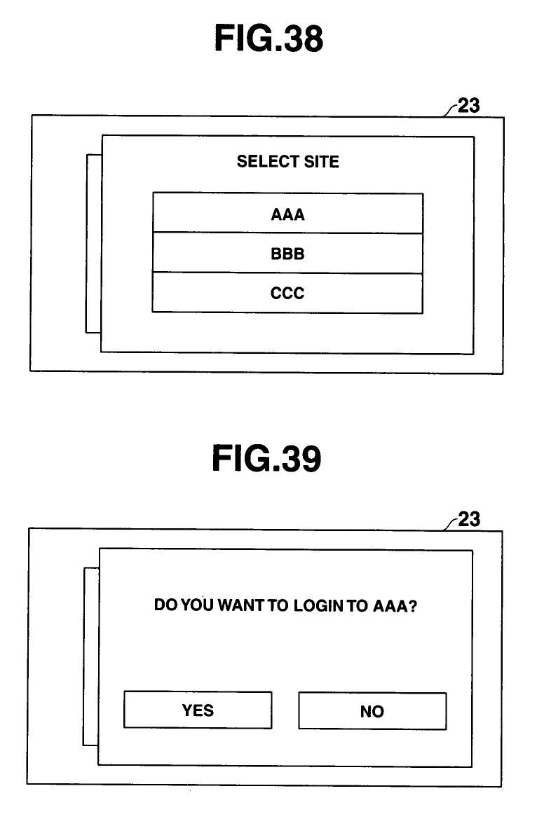

FIG. 38 is a view showing an example of the site names displayed on the display device 23 in step S175. A user can select a desired site name from among site names “AAA”, “BBB”, and “CCC” via the operating device 22, and then, an instruction signal for instructing the thus selected site name is input to the CPU 21.

When a specific site name (for example, “AAA”) is selected, and then, the relevant instruction signal is input by means of a predetermined user operation via the operating device 22 (step S176), a screen (refer to FIG. 39) for checking whether or not to login to an authentication site of the thus selected site name is displayed on the display device 23 (step S177). In the case where instruction information indicative of disabling login has been input (step S178: No), the current routine returns to step S175 in which the site names notified from the login management server 60 are displayed again in a list on the display device 23.

In the case where instruction information indicative of carrying out login has been input in step S178 (step S178: Yes), instruction information for instructing the selected site name is transmitted to the login management server 60 (step S179).

When the login management server 60 receives instruction information for instructing a specific site name from the access terminal 20 (step S194), the account information management table 644 is referred to, and then, it is determined whether or not a seed number is registered in association with the thus instructed site name (step S195).

In the case where it is determined that no seed number is registered in association with the instructed site name, i.e., a fixed password is registered in association therewith in step S195 (step S195: No), the URL, login ID, and fixed password associated with the thus instructed site name are read out from the account information management table 644 (step S196). Then, a variety of the thus read out information are transmitted to the access terminal 20 (step S197). Then, the process of the OTP generator 10 terminates.

In the case where it is determined that a seed number is registered in association with an instructed site name in step S195 (step S195: Yes), the URL, login ID, and seed number associated with the thus instructed site name are read out (step S198). Then, together with a variety of the thus read out information, an OTP flag indicating that the various information is provided as information relevant to an OTP is transmitted to the access terminal 20 (step S199). Then, the process of the login management server 60 terminates.

When the access terminal 20 receives a variety of information from the login management server 60 (step S180), it is determined whether or not the OTP flag is included in this information. In the case where it is determined that no OTP flag is included (step S181: No), the current routine moves to step S184 in which the login ID and fixed password included in the information are transmitted to the URL included in the information received in step S180, whereby login is carried out (step S184). Then, this process terminates.

In the case where it is determined that the OTP flag is included in step S181 (step S181: Yes), instruction information for notifying a seed number (seed number notification information) is transmitted to the OTP generator 10 from among items of information received in step S180 (step S182).

When the OTP generator 10 receives the seed number notification information from the access terminal 20 (step S201), the seed information associated with the thus notified seed number is read out from the seed table 145 (step S202). Then, an OTP is generated based on this seed information and the time information input from the clock device 16 (step S203). The instruction information for notifying the thus generated OTP (OTP notification information) is transmitted to the access terminal 20 (step S204), and then, the process of the OTP generator 10 terminates.

When the access terminal 20 receives the OTP notification information from the OTP generator 10 (step S183), the login ID included in the information and the OTP notified in step S183 are transmitted to the URL included in the information received in step S180, whereby login is carried out for an authentication site targeted for connection (step S184). Then, this process terminates.

As has been described above, according to the present invention, an OTP or a fixed password can be transmitted to an authentication site in accordance with an authentication scheme of the authentication site (RP authentication server 30 or OTP authentication server 40) that serves as a connection destination. Thus, convenience relevant to connection to an authentication site can be improved.

### Fourth Embodiment

Now, the fourth embodiment of the present invention will be described here.

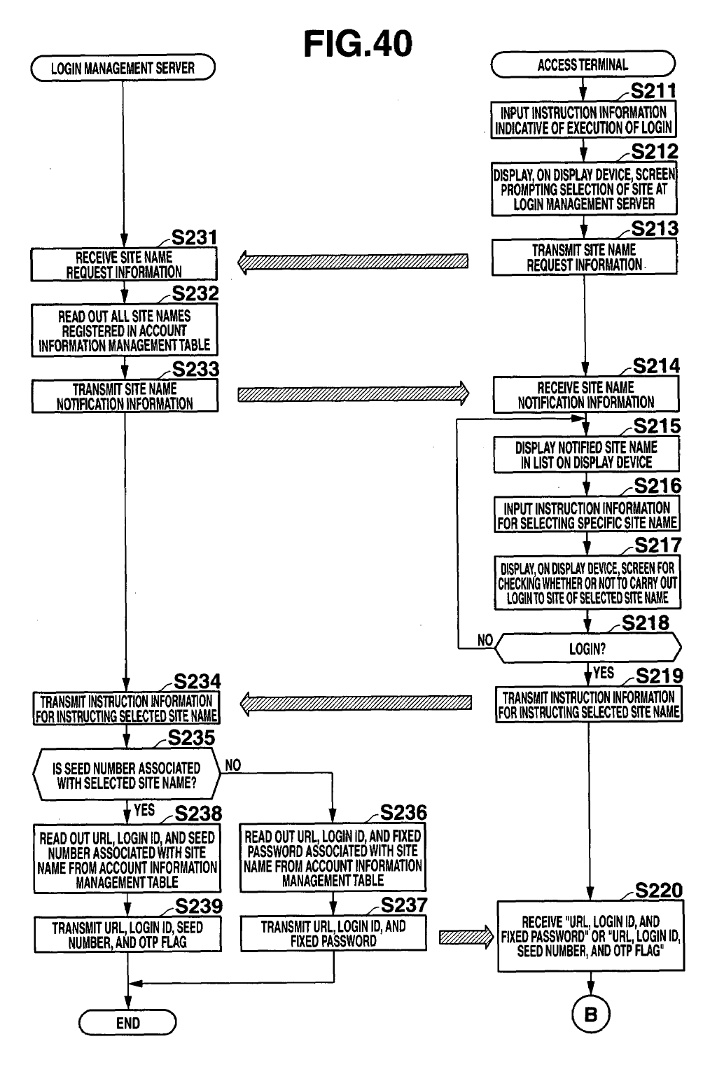

Referring to FIGS. 40 to 44, a description will be given with respect to an operation made at the time of carrying out login from the access terminal 20 to the RP authentication server 30 or the OTP authentication server 40. According to the present embodiment, it is assumed that the OTP generator 10 and the access terminal 20 are not connected to each other via the I/F device 18 or the I/F device 27, and configure the authentication system 100 in a state in which they are independent of each other.

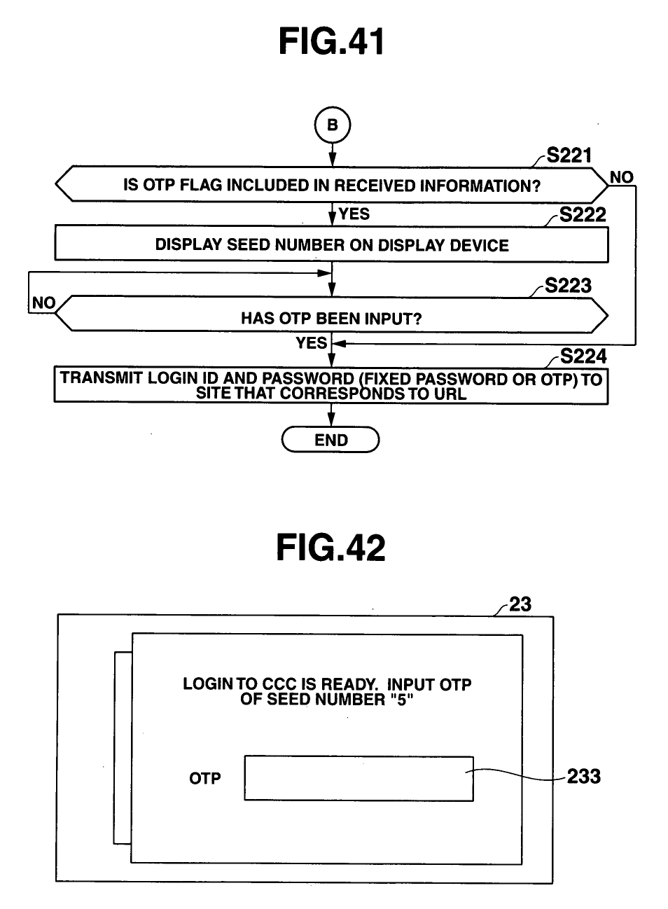

FIGS. 40 and 41 are ladder charts showing procedures executed by means of the access terminal 20 and the login management server 60 at the time of login to the RP authentication server 30 or the OTP authentication server 40. In the figures, each of the processes in steps S211 to S224 shows a process to be executed under cooperation with the CPU 21 of the access terminal 20 and a variety of programs stored in the storage device 24. Each of the processes in steps S231 to S239 shows a process to be executed under cooperation with the CPU 61 of the login management server 60 and a variety of programs stored in the storage device 64.

At the access terminal 20, when instruction information indicative of carrying out login is input by means of a predetermined user operation via the operating device 22 (step S211), a screen for prompting selection of a connection destination at the login management server 60 (refer to FIG. 37) is displayed on the display device 23 (step S212). Then, instruction information for requesting all the site names registered in an account information management table 644 (site name request information) is transmitted to the login management server 60 (step S233).

When the login management server 60 receives the site name request information from the access terminal 20 (step S231), all the site names registered in the account information management table 644 are read out (step S232). Then, instruction information for notifying the thus read out site names (site name notification information) is transmitted to the access terminal 20 (step S233).

When the access terminal 20 receives the site name notification information from the login management server 60 (step S214), the site names notified in accordance with this site name notification information are displayed in a list on a display device 13 in a selectable mode via the operating device 12 (step S215). The screen displayed here is similar to that of FIG. 38 described above. Thus, a detailed description thereof is omitted here.

When a specific site name (for example, “CCC”) is selected by means of a predetermined user operation via the operating device 22, and then, the relevant instruction signal is input (step S216), a screen for checking whether or not to carry out login to an authentication site of the thus selected site name is displayed on the display device 23 (step S217). In the case where instruction information indicative of disabling login has been input (step S218: No), the current routine returns to step S215 in which the site names notified from the login management server 60 are displayed again in a list on the display device 23.

In the case where instruction information indicative of carrying out login has been input in step S218 (step S218: Yes), instruction information for instructing the selected site name is transmitted to the login management server 60 (step S219).

When the login management server 60 receives instruction information for instructing a specific site name from the access terminal 20 (step S234), the account information management table 644 is referred to, and then, it is determined whether or not a seed number is registered in association with the thus instructed site name (step S235).

In the case where it is determined that no seed number is registered in association with the instructed site name, i.e., a fixed password is registered in association therewith (step S235: No), the URL, login ID, and fixed password associated with the thus instructed site name are read out from the account information management table 644 (step S236). A variety of the thus read out information is transmitted to the access terminal 20 (step S237), and then, the process of the OTP generator 10 terminates.

In the case where it is determined that the seed number is registered in association with the instructed site name in step S235 (step S235: Yes), the URL, login ID, and seed number associated with the thus instructed site name are read out (step S238). Together with a variety of the thus read out information, an OTP flag indicating that the various information is provided as information relevant to an OTP is transmitted to the access terminal 20 (step S239). Then, the process of the login management server 60 terminates.

When the access terminal 20 receives a variety of information from the login management server 60 (step S220), it is determined whether or not an OTP flag is included in this information. In the case where it is determined that the OTP flag is not included (step S221: No), the current routine moves to step S224 in which the login ID and fixed password included in the information are transmitted to the URL included in the information received in step S180, whereby login is carried out (step S224). Then, this process terminates.

In the case where it is determined that the OTP flag is included in step S221 (step S221: Yes), an image indicating notification of a seed number is displayed on the display device 23 from among items of the information received in step S180 (step S222), and then, the OTP input is requested (step S223: No).

FIG. 42 is a view showing an example of a screen displayed on the display device 23 in step S222. The figure shows an example of displaying a site name “CCC” selected in step S216 together with a seed number “5”.

Here, the seed number displayed on the display device 23 is input to the OTP generator 10 via the operating device 12, and then, the OTP generated by means of the OTP generator 10 is input to an OTP input area 233 via the operating device 22.

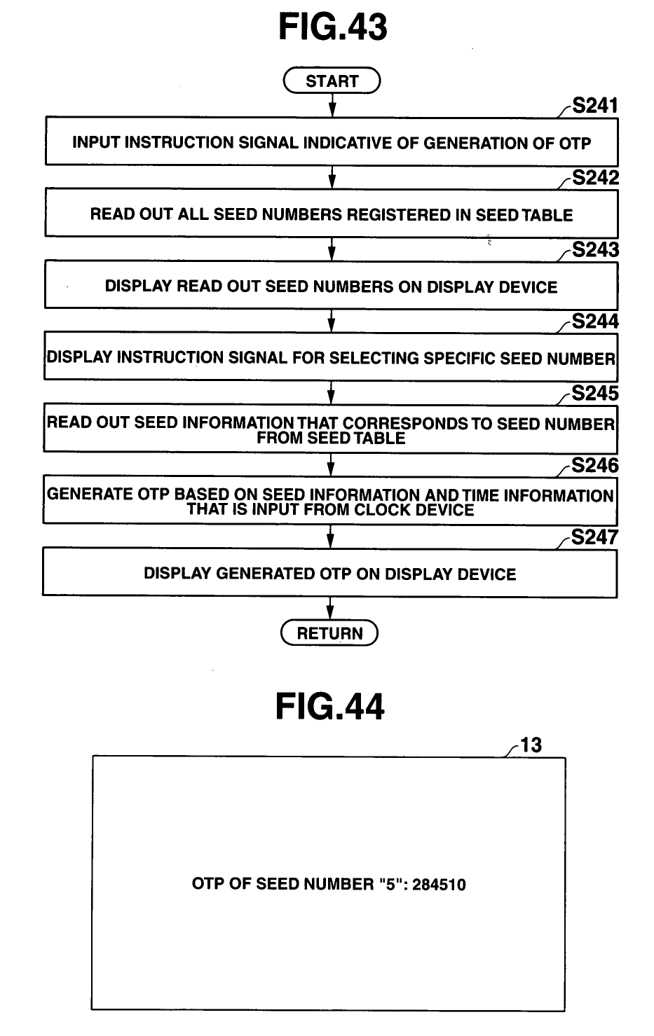

FIG. 43 is a flow chart showing a flow of a process executed by means of the OTP generator 10. This process shows a process to be executed under cooperation with the CPU 11 and a variety of programs stored in the ROM 14.

When instruction information indicative of generation of an OTP has been input by means of a predetermined user operation via the operating device 12 (step S241), all the seed numbers stored in the seed table 145 are read out (step S242). A plurality of the thus read out seed numbers are displayed on the display device 13 in a selectable mode via the operating device 12 (step S243).

When the seed number displayed on the display device 23 of the access terminal 20 is selected, and then, the relevant instruction signal is input by means of a predetermined user operation via the operating device 12 (step S244), the seed information corresponding to the thus input seed number is read out from the seed table 145 (step S245). An OTP is generated based on the thus read out seed information and the time information input from the clock device 16 (step S246). The thus generated OTP is displayed on the display device 13 (step S247), and then, this process terminates.

FIG. 44 is a view showing an example of an OTP displayed on the display device 13, in step S247. The figure shows an example of displaying a seed number “5” relevant to the OTP together with an OTP “284510”.

Turning to FIG. 41, when the OTP displayed on the display device 13 of the OTP generator 10 is input, and then, the relevant instruction signal is input by means of a predetermined user operation via the operating device 22 (step S223: Yes), the login ID included in the information and the OTP input in step S223 are transmitted to the URL included in the information received in step S220, whereby login is carried out to an authentication site targeted for connection (step S224). Then, this process terminates.

As has been described above, according to the present embodiment, the OTP or fixed password can be displayed in accordance with an authentication scheme of an authentication site (RP authentication server 30 or OTP authentication server 40) that serves as a connection destination. Thus, the password according to the connection destination can be notified to a user. This password can be transmitted to the authentication site. Therefore, convenience relevant to connection to an authentication site can be improved.

The embodiments described above can be changed as follows.

For example, while in the foregoing embodiments the account information management table is stored in the OTP generator 10 or the login management server 60, this table may be stored in the storage device 24 of the access terminal 20. In this case, it is assumed that the account information management program is also stored in the storage device 24, and then, functions relevant to storage/management of the account information management table are implemented under cooperation between this account information management program and the CPU 21.

### Fifth Embodiment

Now, a fifth embodiment of the present invention will be described below in detail.

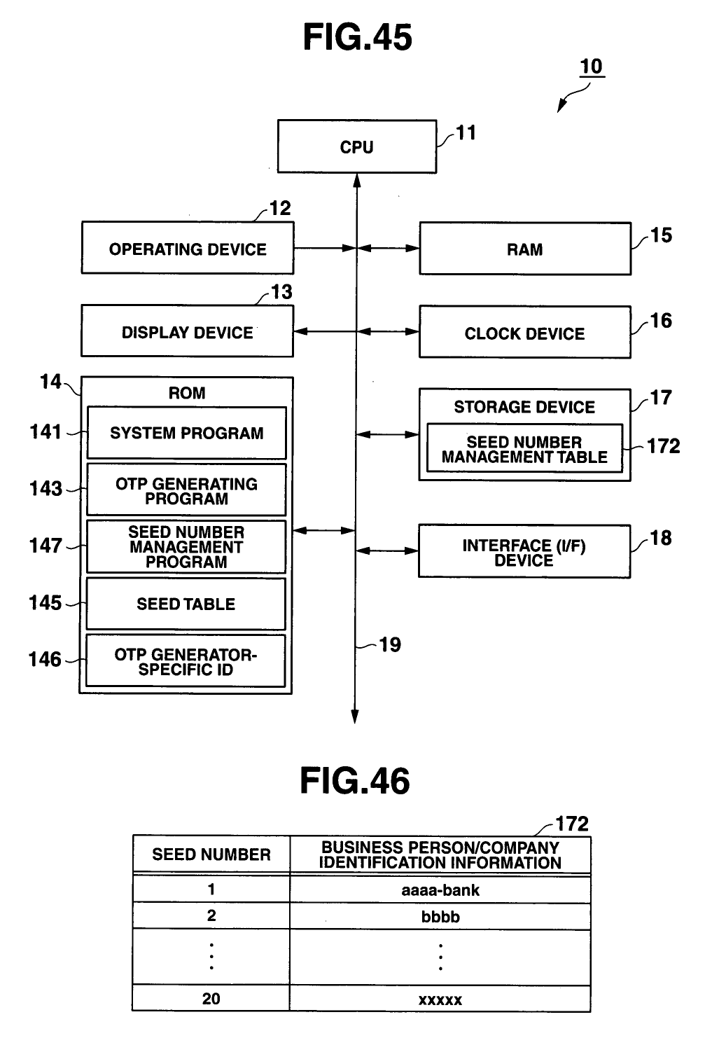

FIG. 45 is a block diagram showing an internal configuration of the OTP generator 10 of the fifth embodiment. The OTP generator 10 includes the CPU 11, operating device 12, display device 13, ROM 14, RAM 15, clock device 16, storage device 17, and I/F device 18. Constituent elements are connected via the bus line 19.

The CPU 11 executes a variety of processes under cooperation with a variety of programs stored in advance in the ROM 14 while the RAM 15 is used as a work area. The CPU 11 controls an operation of each of constituent elements that configure the OTP generator 10.

The operating device 12 is equipped with a variety of input keys or the like, and outputs to the CPU 11 an input signal input by means of a user operation. The display device 13 includes a panel such as an LCD (Liquid Crystal Display) or ELD (Electro Luminescence Display) panel, and displays a variety of information based on a display signal from the CPU 11. The display device 13 may configure a touch panel integrally with the operating device 12.

The ROM 14 stores a program required for an operation of the OTP generator 10 and data relevant to execution of the program. The ROM 14, as shown in FIG. 45, stores the system program 141, the OTP generating program 143, a seed number management program 147, the seed table 145, and the OTP generator-specific ID 146.

The system program 141 is provided as a program for implementing basic functions as an OTP generator. The CPU 11 implements read/write control of a variety of data with respect to the storage device 17, display control of the display device 13, input control of assigning execution of a predetermined function to a predetermined input key of the operating device 12, and the like, under cooperation with the system program 141.

The OTP generating program 143 is provided as a program for implementing functions relevant to generation of an OTP. The CPU 11 generates an OTP by a predetermined algorithm based on one item of seed information and time information input from the clock device 16 under cooperation with the OTP generating program 143.

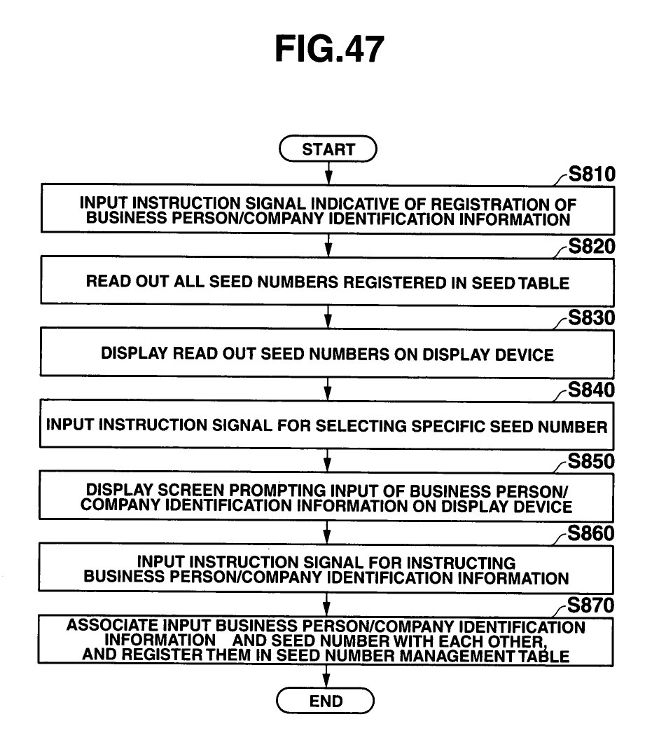

The seed number management program 147 is provided as a program for implementing functions relevant to registration/management of a seed number management table 172 stored in the storage device 17. The CPU 11 executes a seed number managing process described later (refer to FIG. 47) under cooperation with the seed number management program 143.

In the seed table 145, as shown in FIG. 3 described above, a plurality of items of seed information are registered in association with a plurality of seed numbers (selection information), each of which corresponds to each one of the plurality of items of seed information.

When a user selects a specific seed number via the operating device 12, the CPU 11 reads out from the seed table 145 the seed information that corresponds to the selected seed number, and then, generates an OTP based on the thus read out seed information under cooperation with the OTP generating program 142 described above. The CPU 11 causes the display device 13 to display the thus generated OTP or transmits the OTP to an external device via the I/F device 18 in response to a predetermined user operation via the operating device 12.

The OTP generator-specific ID 146 is provided as a specific ID such as a manufacturing number assigned to each OTP generator 10. In response to a predetermined user operation via the operating device 12, the CPU 11 reads out the OTP generator-specific ID 146 from the ROM 14, and then, transmits the OTP generator-specific ID 146 to an external device via the I/F device 18 or causes the display device 13 to display the ID.

The RAM 15 is provided as a temporary storage area for programs, input or output data, and parameters read out from the ROM 14 in a variety of processes executed and controlled by means of the CPU 11.

The clock device 16 measures a current time based on a clock signal generated by a quartz oscillator (not shown) which always generates a predetermined frequency signal, and then, outputs the thus measured clock information to the CPU 11.

The storage device 17 is equipped with a nonvolatile storage medium formed of a magnetic or an optical recording medium or a semiconductor memory, and stores a seed number management table 172 relevant to a seed number managing process described later (refer to FIG. 47). This storage medium may be configured to be removably mountable on the OTP generator 10.

In the seed number management table 172, seed numbers corresponding to items of seed information stored in the seed table 145 are registered in association with business person/company identification information relevant to an OTP authentication server that carries out authentication of an OTP generated based on the items of seed information. The business person/company identification information is provided as information input from a user via the operating device 12 in a seed number management process described later (refer to FIG. 47), so that a name of a business person/company or the like to which each OTP authentication server belongs can be input, for example.

FIG. 46 is a view showing an example of the seed number management table 172. In the seed number management table 172, a seed number and business person/company identification information relevant to the seed number are registered in association with each other. The CPU 11 refers to the seed number management table 172 in response to a user operation from the operating device 12, and then, transmits a specific seed number and a business person/company name associated with the seed number to an external device via the I/F device 18 or causes the display device 13 to display them.

The I/F device 18 is provided as a communication interface that makes communication control of a variety of information exchanged between the OTP generator 10 and an external device such as the access terminal 20, under the control of the CPU 11. As the I/F device 18, for example, there are constituent elements such as a serial input/output terminal represented by a USB (Universal Serial Bus) port or an RS-232C terminal, a parallel input/output terminal, an SCSI interface, an infrared ray communication device that conforms to an IrDA (Infrared Data Association) standard, and a radio communication device that conforms to a Bluetooth standard. Each of these constituent elements can be connected to the I/F device 27 of the access terminal 20 by wired or radio communication means. Specifically, a variety of information such as a seed number, an OTP generator-specific ID, and an OTP are transmitted from the OTP generator 10 to the access terminal 20 via the I/F device 18.

FIG. 47 is a flow chart showing procedures for carrying out a process (seed number management process) relevant to registration into the seed number management table 172. This process shows a process to be executed under cooperation between the CPU 11 and a variety of programs stored in the ROM 14.

When an instruction signal indicative of registration of business person/company information is input by means of a predetermined user operation via the operating device 12 (step S810), all the seed numbers registered in the seed table 144 are read out (step S820). All the thus read out seed numbers are displayed on the display device 13 in a selectable mode via the operating device 12 (step S830).

When a specific seed number is selected, and then, the relevant instruction signal is input by means of a predetermined user operation via the operating device 12 (step S840), a screen prompting input of business person/company identification information is then displayed on the display device 13 (step S850).

Then, when the business person/company identification information is input, and then, the relevant instruction signal is input by means of a predetermined user operation via the operating device 12 (step S860), the thus input business person/company identification and the seed number selected in step S840 are registered into the seed number management table 172 in association with each other (step S870). Then, this process is terminated.

In this way, even in the case where a plurality of items of seed information have been stored in one OTP generator 10, the seed information management server 50 can transmit proper seed information to the OTP authentication server 40 that corresponds to each one of the plurality of items of seed information. Thus, convenience relevant to management and utilization of seed information can be improved.

In the case where a plurality of items of seed information have been stored in one OTP generator 10, the OTP authentication server 40 stores one item of seed information responsive to one's own OTP authentication server 40 from among the plurality of items of seed information, enabling authentication based on this seed information. Convenience relevant to management and utilization of seed information can thus be improved.

### Operation at the Time of Login

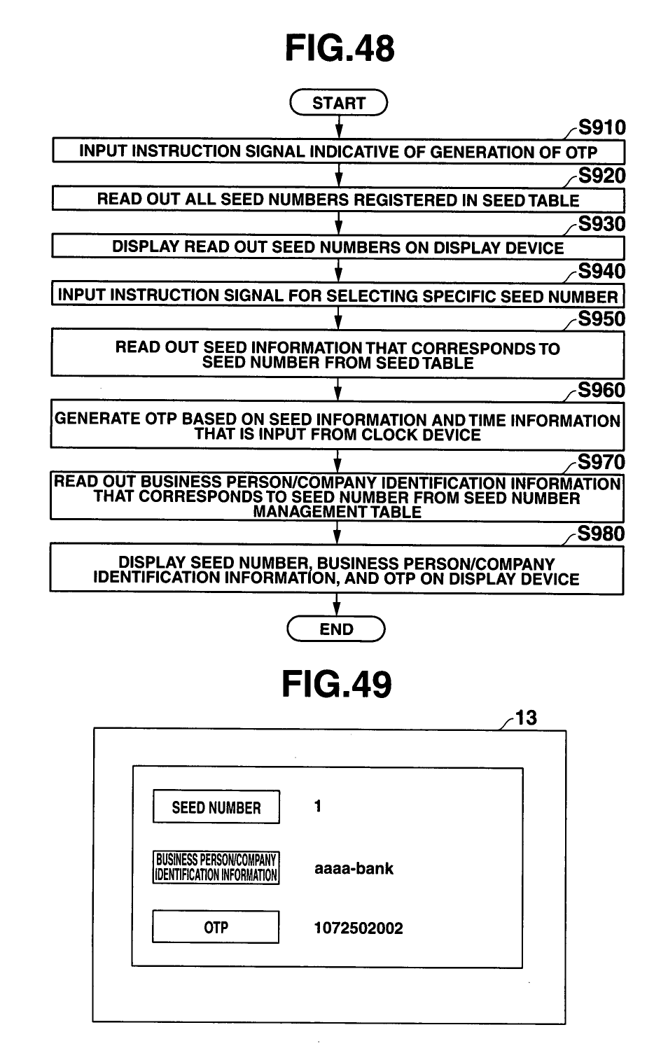

Referring to FIGS. 48 to 50, a description will be given with respect to an operation made at the time of carrying out login from the access terminal 20 to the OTP authentication server 40.

FIG. 48 is a flow chart showing a process executed by means of the OTP generator 10 at the time of login. This process shows a process to be executed under cooperation between the CPU 11 and a variety of programs stored in the ROM 14.

When instruction information indicative of generation of an OTP is input by means of a predetermined user operation via the operating device 12 (step S910), all the seed numbers stored in the seed table 145 are read out (step S920), and then, all the thus read out seed numbers are displayed on the display device 13 in a selectable mode via the operating device 12 (step S930). Among the read out seed numbers, with respect to the seed numbers registered in the seed number management table 172, business person/company identification information associated with each seed number is read out from the seed number management table 172, whereby the read out information may be displayed together with the corresponding seed information.

When a specific seed number is selected, and then, the relevant instruction signal is input by means of a predetermined user operation via the operating device 12 (step S940), seed information corresponding to the thus input seed number is read out from the seed table 145 (step S950), and then, an OTP is generated based on the seed information and the time information input from the clock device 16 (step S960). In this way, one seed number is specified from a plurality of seed numbers displayed on the display device 13, whereby one item of seed information corresponding to the thus specified seed number can be selected. Thus, convenience relevant to management and utilization of seed information can be improved.

The business person/company identification information corresponding to the seed number selected in step S940 is read out from the seed number management table 172 (step S970). The seed number selected in step S940, the business person/company identification information read out in step S970, and the OTP generated in step S960 are displayed on the display device 13 (step S980), and then, this process terminates.

In this way, the OTP generator 10 can select one item of seed information for generating an OTP from a plurality of items of seed information. Thus, convenience relevant to management and utilization of seed information can be improved.

FIG. 49 is a view showing an example of the seed numbers, business person/company identification information, and OTP displayed on the display device 13. In accordance with the process described above, a seed number “1”, business person/company identification information “aaaa-bank”, and an OTP “1072502002” are displayed on the display device 13 of the OTP generator 10. In this way, the generated OTP and the seed number corresponding to the seed information that becomes a source of generating this OTP are displayed on the display device 13, thus making it possible to notify the OTP and the seed number in a user viewable state.

The user inputs a variety of information displayed on the display device 13 to the access terminal 20 via the operating device 22, and then, transmits the information to a desired OTP authentication server 40, thereby carrying out login to the OTP authentication server 40.

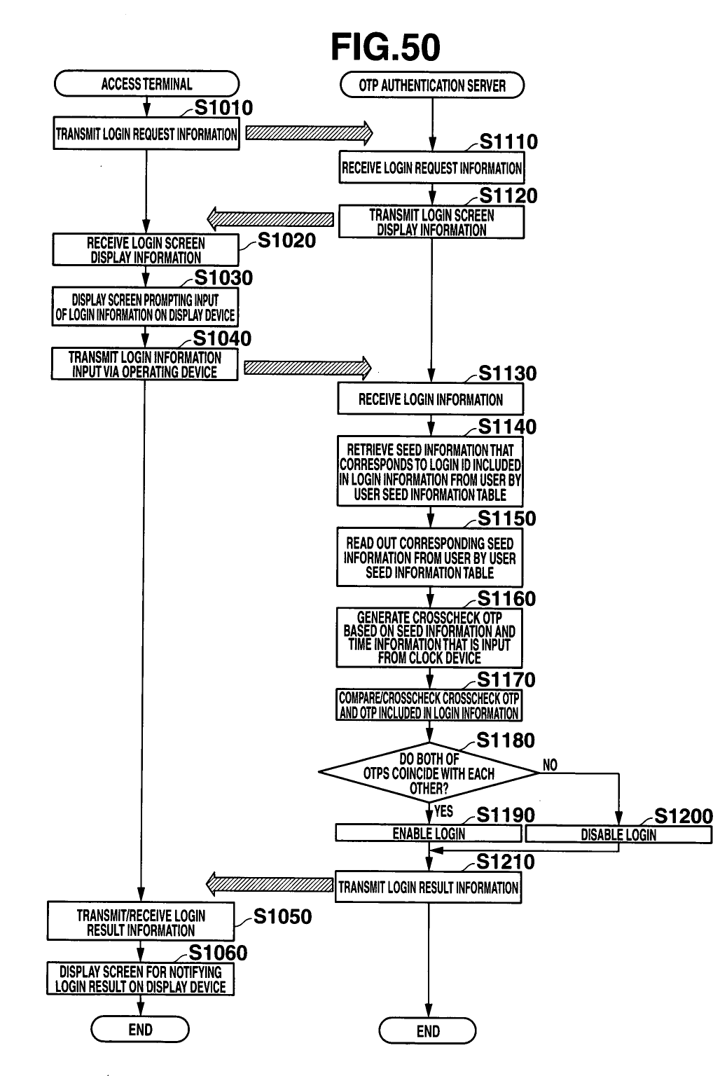

FIG. 50 is a ladder chart showing procedures for carrying out a process relevant to login from the access terminal 20 to the OTP authentication server 40. In the figure, each of the processes in steps S1010 to S1060 shows a process to be executed under cooperation between the CPU 21 of the access terminal 20 and a variety of programs stored in the storage device 24. Each of the processes in steps S1110 to S1210 shows a process to be executed under cooperation between the CPU 41 of the OTP authentication server 40 and a variety of programs store in the storage device 44.

In the access terminal 20, in response to a predetermined user operation via the operating device 22, instruction information indicative of login (login request information) is transmitted to a specific OTP authentication server 40 (step S1010).

When the OTP authentication server 40 receives the login request information from the access terminal 20 (step S1110), instruction information for instructing display of a screen prompting input of login information such as a login ID and an OTP (login screen display information) is transmitted to the access terminal 20 (step S1120).

When the access terminal 20 receives the login screen display information from the OTP authentication server 40 (step S1020), a screen prompting input of login information (refer to FIG. 32) is displayed on the display device 23, based on this login screen display information (step S1030). When login information such as a login ID or an OTP is input via the operating device 12 based on the screen displayed on the display device 23, the thus input login information is transmitted to the business person/company authentication server 30 (step S1040).

Here, although it is assumed that the OTP input as login information is input as the OTP displayed on the display device 13 of the OTP generator 10 (for example, 1072502002), its input mode is not particularly limited. It may be input from the user via the operating device 22 or, in the case where the OTP generator 10 is connected to the I/F device 27, may be input from the OTP generator 10.

When the OTP authentication server 40 receives login information from the access terminal 20 (step S1130), the seed information corresponding to the login ID included in this login information is retrieved from the user by user seed information table 443 (step S1140), and then, the corresponding seed information is read out from the user by user seed information table 443 (step S1150). A crosscheck OTP is generated based on this seed information and the time information input from the clock device 46 (step S1160), and then, this crosscheck OTP and an OTP included in the login information are compared and crosschecked with each other (step S1170).

It is determined whether or not one OTP coincides with the other OTP. In the case where it is determined that the OTPs coincide with each other (step S1180: Yes), login to the OTP authentication server 40 is allowed (step S1190), and then, the current routine moves to step S1210. On the other hand, in the case where the OTPs do not coincide in step S1180 (step S1180: No), login to the OTP authentication server 40 is not allowed (step S1200), and then, the current routine moves to step S1210.

In step S1210, instruction information indicative of a login result determined in step S1190 or step S1200 (login result information) is transmitted to the access terminal 20 (step S1210), and the process of the OTP authentication server 40 terminates.

When the access terminal 20 receives the login result information from the OTP authentication server 40 (step S1050), a screen for notifying the login result is displayed on the display device 23 based on this login result information (step S106), and then, the process of the access terminal 20 terminates.

As has been described above, even in the case where a plurality of items of seed information have been stored in one OTP generator 10, seed information responsive to the OTP authentication server 40 that corresponds to each one of the plurality of items of seed information can be stored in each OTP authentication server 40. Based on this seed information, a user who owns the OTP generator 10 can be authenticated. Thus, convenience relevant to management and utilization of seed information can be improved.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

For example, the present invention can be practiced as a computer readable recording medium in which a program for allowing the computer to function as predetermined means, allowing the computer to realize a predetermined function, or allowing the computer to conduct predetermined means. While the foregoing embodiments have described that the seed number management table 172 is stored in the OTP generator 10, this table may be stored in the storage device 24 of the access terminal 20. In this case, the seed number management program 147 may also be stored in the storage device 24 of the access terminal 20, and then, functions relevant to storage/management of the seed number management table may be achieved under cooperation between the seed number management program 147 and the CPU 21.

In addition, while the foregoing embodiments have described that the OTP generator 10 and the access terminal 20 configures the authentication system 100 in a state in which they are independent of each other, the present invention is not limited thereto. For example, the OTP generator 10 and the access terminal 20 are connected to each other via the I/F device 18 and the I/F device 27, whereby the access terminal 20 may directly transmit a variety of information transmitted from the OTP generator 10 to the OTP authentication server 40. In this manner, the user's work relevant to login can be reduced.

What is claimed is:

1. An identification information output device comprising:
a storage unit configured to store items of seed information for generating identification information;
a selection unit configured to select one of the items of the seed information stored in the storage unit in response to a user operation;
a generation unit configured to generate identification information based on a predetermined algorithm using the item of the seed information selected by the selection unit; and
an output unit configured to output the identification information generated by the generation unit.

2. The identification information output device according to claim 1, wherein
the storage unit stores items of selection information, each of which corresponds to each of the items of seed information, and
the selection unit selects an item of seed information that corresponds to the item of selection information specified by a user.

3. The identification information output device according to claim 2, further comprising a display unit, and
wherein the selection unit causes the display unit to display the items of selection information stored in the storage unit and selects an item of seed information that corresponds to the item of selection information displayed on the display unit and specified by a user.

4. The identification information output device according to claim 1, further comprising a display unit, and
wherein the output unit causes the display unit to display the identification information generated by the generation unit.

5. The identification information output device according to claim 4, wherein the output unit causes the display unit to display an item of selection information that corresponds to an item of seed information which is a basis of the identification information generated by the generation unit.

6. The identification information output device according to claim 1, further comprising a communication unit, and
wherein the output unit causes the communication unit to transmit the identification information generated by the generation unit.

7. The identification information output device according to claim 6, wherein the output unit causes the communication unit to transmit an item of selection information that corresponds to an item of seed information which is a basis of the identification information generated by the generation unit.

8. The identification information output device according to claim 1, further comprising an identifier storage unit configured to store an identifier specific to each identification information output device, and
wherein the output unit outputs the identifier stored in the identifier storage unit.

9. The identification information output device according to claim 8, further comprising a display unit, and
wherein the output unit causes the display unit to display the identifier stored in the identifier storage unit.

10. The identification information output device according to claim 8, further comprising a communication unit, and
wherein the output unit causes the communication unit to transmit the identifier stored in the identifier storage unit.

11. An identification information output device comprising:
a seed information storage unit configured to store an item or items of seed information corresponding to one or plural authentication sites that carry out authentication based on a one time password for crosscheck;
a generation unit configured to generate a one time password based on a predetermined algorithm using the item or items of seed information stored in the seed information storage unit;
a fixed identification information storage unit configured to store an item or items of fixed identification information corresponding to one or plural authentication sites that carry out authentication based on a one time password for crosscheck;
a readout unit configured to read out the item or items of fixed identification information stored in the fixed identification information storage unit;
a control unit configured to, in accordance with an authentication scheme of an authentication site of a connection destination, cause the generation unit to generate a one time password corresponding to the authentication site of a connection destination or the readout unit to read out the item of fixed identification information corresponding to the authentication site of a connection destination; and
an output unit configured to output the one time password generated by the generation unit or the item of fixed identification information read out by the readout unit.

12. The identification information output device according to claim 11, further comprising a determination unit configured to determine whether or not the authentication site of a connection destination corresponds to a one time password authentication scheme, and wherein
the control unit is configured to cause the generation unit to generate a one time password corresponding to the authentication site of a connection destination or the readout unit to read out the item of fixed identification information corresponding to the authentication site of a connection destination in accordance with a result of determination made by the determination unit.

13. The identification information output device according to claim 12, further comprising an account information storage unit configured to associate and store account information including at least information relevant to the item of seed information or the item of fixed identification information for each authentication site, and
wherein the determination unit determines whether or not the authentication site corresponds to a one time password authentication scheme based on a content of the account information.

14. The identification information output device according to claim 11, wherein the output unit outputs a site name, a connection destination address, and login identification information of an authentication site together with the item of one time password or the item of fixed identification information.

15. An identification information output device communicably connected to a terminal device which is connected to authentication sites via a communication network, the output device comprising:
a seed information storage unit configured to store an item or items of seed information corresponding to one or plural authentication sites that carry out authentication based on a one time password for crosscheck;
a generation unit configured to generate a one time password based on a predetermined algorithm using the item or items of seed information stored in the seed information storage unit;
a fixed identification information storage unit configured to store an item or items of fixed identification information corresponding to one or plural authentication sites that carry out authentication based on a one time password for crosscheck;
a readout unit configured to read out the item or items of fixed identification information stored in the fixed identification information storage unit;
a control unit configured to, in accordance with an authentication scheme of an authentication site of a connection destination, cause the generation unit to generate a one time password corresponding to the authentication site of a connection destination or the readout unit to read out the item of fixed identification information corresponding to the authentication site of a connection destination; and
a transmission unit configured to transmit the one time password generated by the generation unit or the item of fixed identification information read out by the readout unit to the terminal device.

16. The identification information output device according to claim 15, further comprising a determination unit configured to determine whether or not the authentication site of a connection destination corresponds to a one time password authentication scheme, and wherein
the control unit is configured to cause the generation unit to generate a one time password corresponding to the authentication site of a connection destination or the readout unit to read out the item of fixed identification information corresponding to the authentication site of a connection destination in accordance with a result of determination made by the determination unit.

17. The identification information output device according to claim 16, further comprising an account information storage unit configured to associate and store account information including at least information relevant to the item of seed information or the item of fixed identification information for each authentication site, and
wherein the determination unit determines whether or not the authentication site corresponds to a one time password authentication scheme based on a content of the account information.

18. The identification information output device according to claim 15, wherein the transmission unit transmits a site name, a connection destination address, and login identification information of an authentication site together with the item of one time password or the item of fixed identification information to the terminal device.
